(19) United States
(12) Patent Application Publication
(10) Pub. No.: US 2024/0419051 A1
(43) Pub. Date: Dec. 19, 2024

(54) APERIODIC OPTICAL SENSORS, MODULATORS, AND ANTENNAS

(71) Applicant: Look Dynamics, Inc., Longmont, CO (US)

(72) Inventor: Rikki J. Crill, Longmont, CO (US)

(73) Assignee: Look Dynamics, Inc., Longmont, CO (US)

(21) Appl. No.: 18/735,044

(22) Filed: Jun. 5, 2024

Related U.S. Application Data
(60) Provisional application No. 63/507,937, filed on Jun. 13, 2023.

(51) Int. Cl. G02F 1/313; G02F 1/01

(52) U.S. Cl. CPC G02F 1/3134; G02F 1/0102

(57) ABSTRACT

Aperiodic arrays of light sensors, light modulators, light emitters, or antenna transmitters or receivers include einstein sensors, modulators, emitters, antenna transmitters, or phased array antenna receivers. Various einstein device embodiments of electrically addressable elements are disclosed.

### BACKGROUND

### Field of the Invention

This invention is related to optical sensors, modulators, and antennas and more specifically to aperiodic arrays for optical sensors, modulators, and antennas.

### State of the Prior Art

Optical sensors are devices that transduce electromagnetic (e.g., light, infra-red, microwave, etc.) photons into electric signals. Arrays of optical sensors, e.g., photodetectors, are commonly used to capture and transduce images into electronic signals that are indicative of the images and which can be stored in memories, transmitted, or processed in various manners, e.g., for visual displays, modifications, analysis, convolutional neural networks, and many other uses. There are several common types of optical detectors, including, for example, diodes, photoconductors, and phototransistors. Some, but not exclusive, examples of common, widely used optical (light) sensors for detecting and transducing images include arrays of charge coupled devices (CCD arrays) and arrays of complementary metal-oxide-semiconductors (CMOS arrays). Each of the sensor elements in an array captures a tiny portion (pixel) of light emanating from an object or image so that the entire object or image is captured in pixels, and each pixel is transduced into an electric charge or signal that is indicative of the brightness (intensity), color, or other characteristic of the light sensed at the respective pixels.

Spatial light modulators are optical devices that selectively reflect, transmit, or block pixels of light in variable shades or degrees of reflection or transmission. Modulation is usually modulation of the intensity of the light, but light can also be modulated by phase of the light. Ferroelectric or nematic liquid crystal devices are common light modulator materials. Spatial light modulators comprising numerous, individually addressable, light modulator elements positioned in a spatial array are commonly used to modulate tiny individual portions or pixels of light beams. Each portion or pixel is individually addressable to modulate the light at that pixel in a desired manner to create or transmit controlled images, information, or other useful spatially modulated light beams.

Phased array antennas in general are arrays of antenna transmitter elements that are controlled electronically to create beams of electromagnetic radiation, e.g., radio waves, that are electronically steerable to point in different directions without moving the antennas or receiver. In a transmitting phased array antenna, radio frequency current from the transmitter is fed through phase shifters to multiple individual antenna elements in an array so that the radio waves from the separate elements combine (superimpose) to form beams, to increase power radiated in desired directions and suppress radiation in undesired directions. The power is controlled by a computer system, which can alter the phase or signal delay electronically, thus steering the beam of radio waves to a different direction. Phased array receiving antennas are similar to phased array transmitting antennas, but the antenna elements in the array receive electromagnetic radiation instead of transmitting, and the received bus signals are phase shifted to increase reception from desired directions and suppress reception from undesired directions.

The foregoing examples of related art and limitations related therewith are intended to be illustrative, but not exclusive or exhaustive, of the subject matter. Other aspects and limitations of the related art will become apparent to those skilled in the art upon a reading of the specification and a study of the drawings.

### BRIEF DESCRIPTION OF THE DRAWINGS

The accompanying drawings, which are incorporated herein and form a part of the specification, illustrate some, but not the only or exclusive, example embodiments and/or features. It is intended that the embodiments and figures disclosed herein are to be considered illustrative rather than limiting. In the drawings:

FIG. 1 is a diagram of a conventional (prior art) square pixel sensor array;

FIG. 2 is a diagram of an example aperiodic pixel element array of einstein electrically addressable elements;

FIGS. 3 and 4 are equivalent sized square and einstein electrically addressable elements, respectively;

FIG. 5 is an enlarged view of the 13-sided einstein shape of each einstein electrically addressable element of the example aperiodic element array in FIG. 2 in the context of geometrically adjacent, equal-sized hexagons from which the einstein shape of the electrically addressable elements is formed;

FIG. 6 shows the twelve rotational orientations of the 13-sided einstein elements and their mirror images that can be tessellated together to form an aperiodic element array;

FIG. 7 is a diagram of an example curve-sided einstein electrically addressable element in which each einstein element in the array has fourteen side segments of equal length and equal arc angle;

FIG. 8 is a straight-sided variation of the example curve-sided einstein electrically addressable element in FIG. 7;

FIG. 9 is an example partial aperiodic array comprised of the curve-sided einstein electrically addressable elements in FIG. 7;

FIG. 10 rotational positions of the curve-sided einstein electrically addressable elements of FIG. 7 that enable tessellation with the elements;

FIG. 11 is a diagrammatic representation of an example design for a curve-sided, aperiodic, einstein electrically addressable element;

FIG. 12 is another variation of the curve-sided einstein electrically addressable element;

FIG. 13 is a variation of the example curve-sided einstein electrically addressable element comprising half-circle curved side sections;

FIG. 14 is a diagram illustrating rotational orientations of the half-circle variation curve-sided einstein electrically addressable element of FIG. 13 for tessellation positions;

FIG. 15 is a “real world” high resolution image of a house in a simulation;

FIG. 16 is the house image of FIG. 15 as seen by a 256×256 square pixel sensor array;

FIG. 17 is the house image of FIG. 15 as seen by a 256×256 a curve-sided einstein electrically addressable element pixel array;

FIG. 18 is a square tile array with white edges sample;

FIG. 19 is an array of curve-sided einstein tiles with white edges sample;

FIG. 20 is a square tile white-edged grid Fourier transform;

FIG. 21 is a curve-sided einstein white-edged Fourier transform;

FIG. 22 is a square tile Fourier transform of the house image;

FIG. 23 is a curve-sided einstein tile Fourier transform of the house image;

FIG. 24 is the center of the square tile Fourier transform of the house image;

FIG. 25 is the center of curve-sided einstein tile Fourier transform of the house image;

FIG. 26 is the extreme center of the square tile Fourier transform of the house image;

FIG. 27 is the extreme center of the curve-sided einstein tile Fourier transform of the house image;

FIG. 28 is an example single einstein micro-lens;

FIG. 29 is an example einstein micro-lens array;

FIG. 30 is a typical phased array antenna;

FIG. 31 is a typical square element array;

FIG. 32 is a square element array at 0°;

FIG. 33 is a square element array at 45°;

FIG. 34 is an einstein phased-array antenna at 0°;

FIG. 35 is an einstein phased-array antenna at 45°;

FIG. 36 is an einstein phased-array antenna at 135°;

FIG. 37 is a diagrammatic view of periodic antenna elements;

FIG. 38 is a diagrammatic view of aperiodic antenna elements;

FIG. 39 is the Fourier transform of the periodic antenna elements in FIG. 37; and

FIG. 40 is the Fourier transform of the aperiodic antenna elements in FIG. 38.

### DETAILED DESCRIPTION OF EXAMPLE EMBODIMENTS

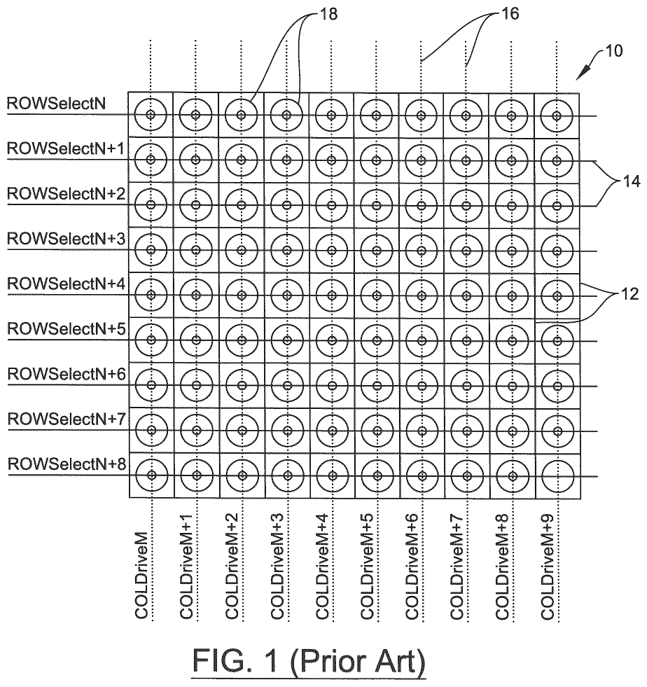

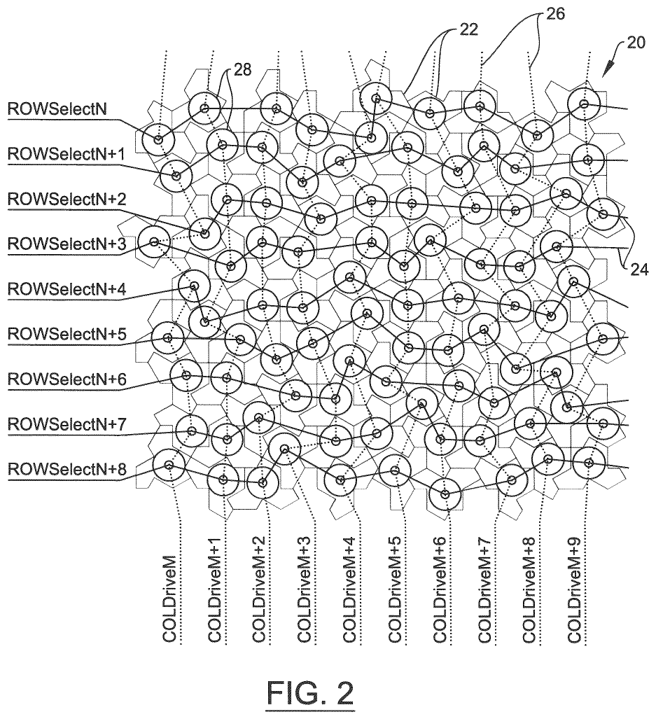

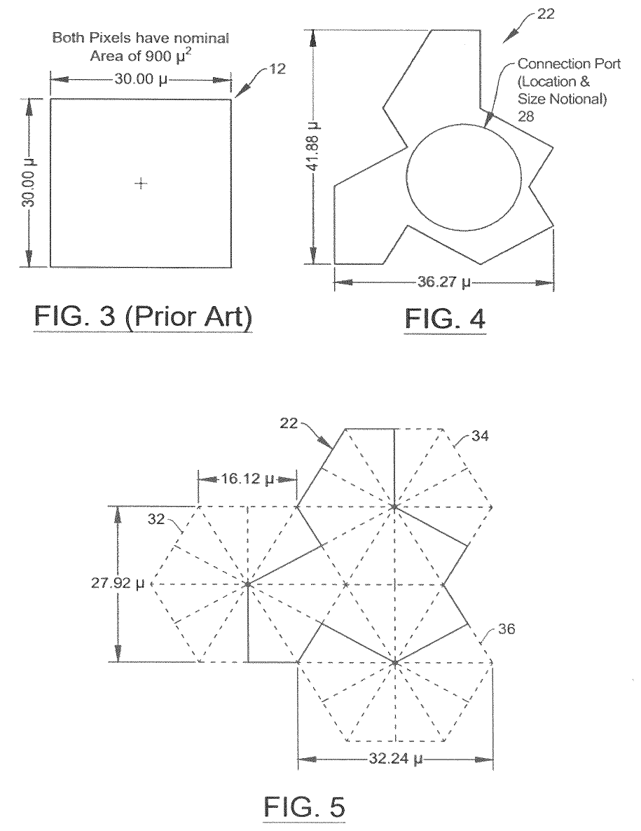

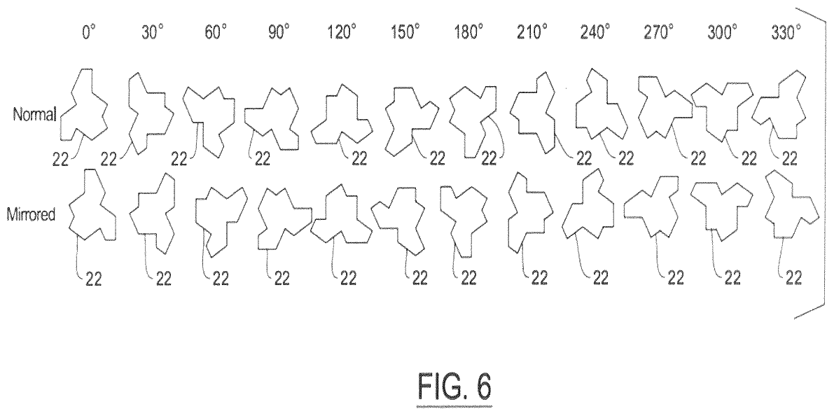

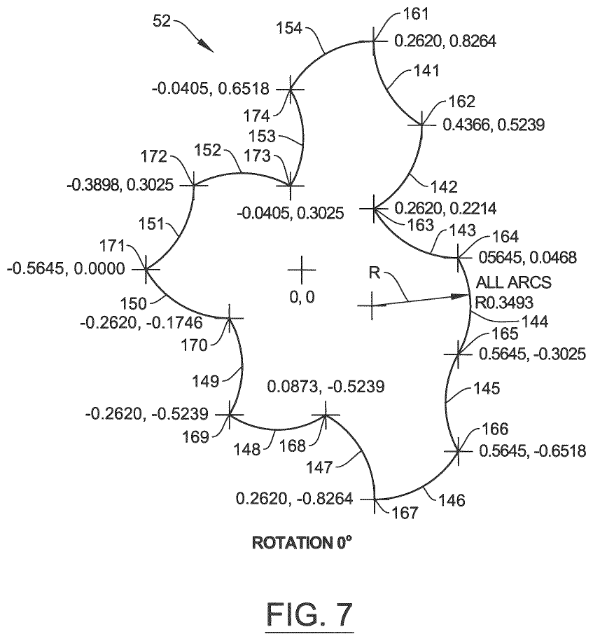

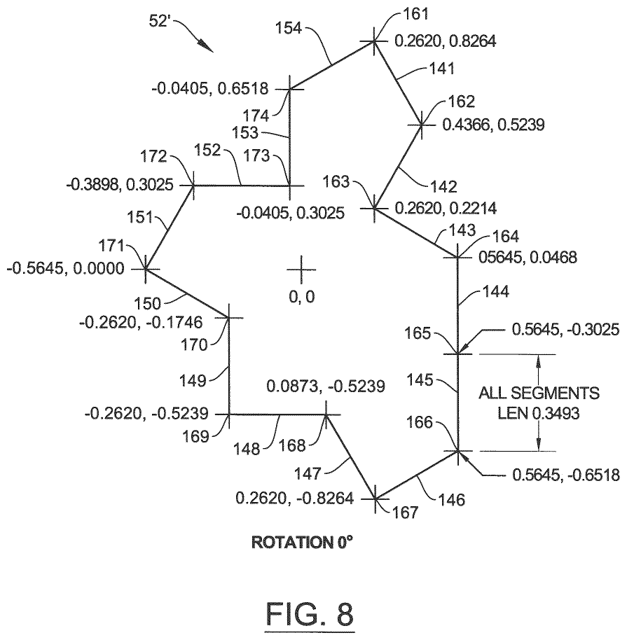

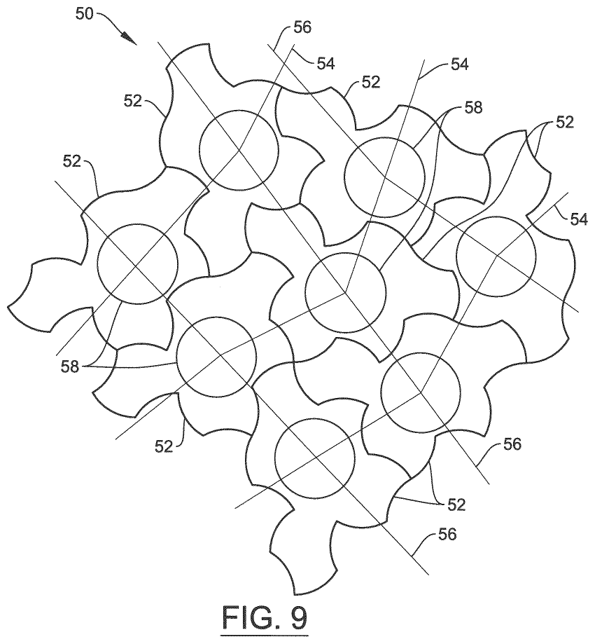

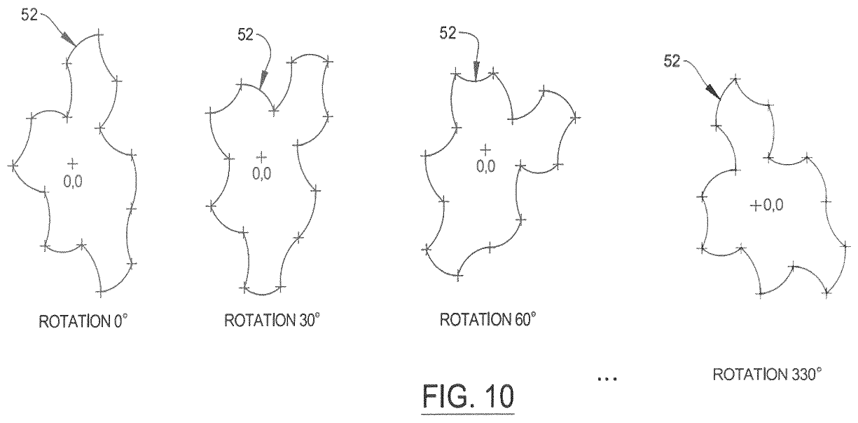

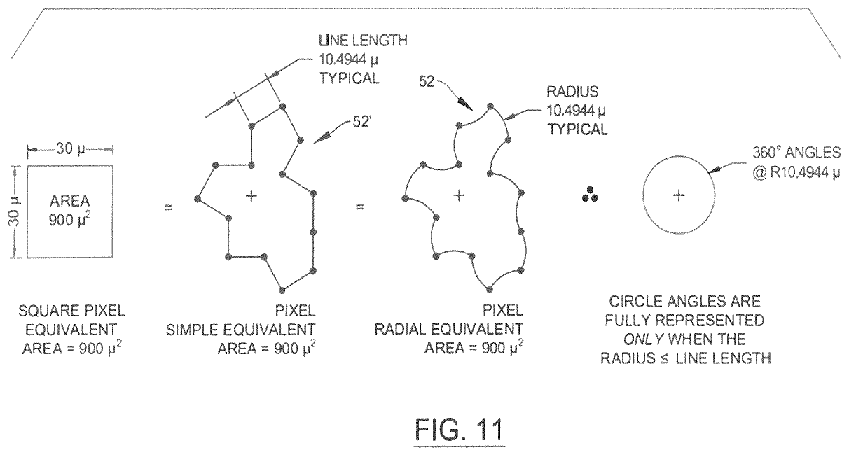

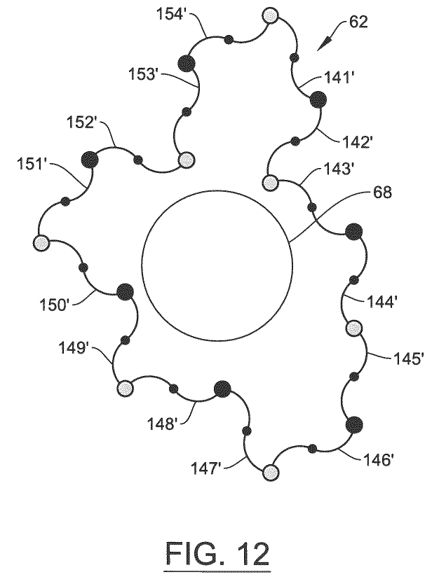

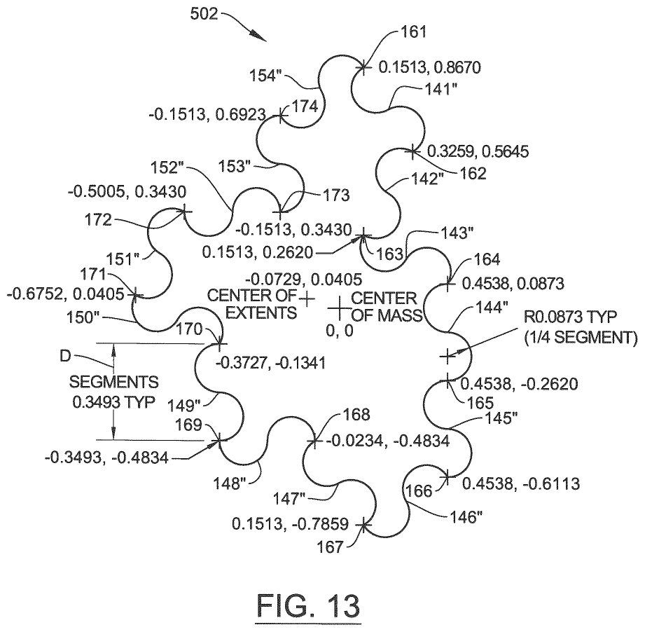

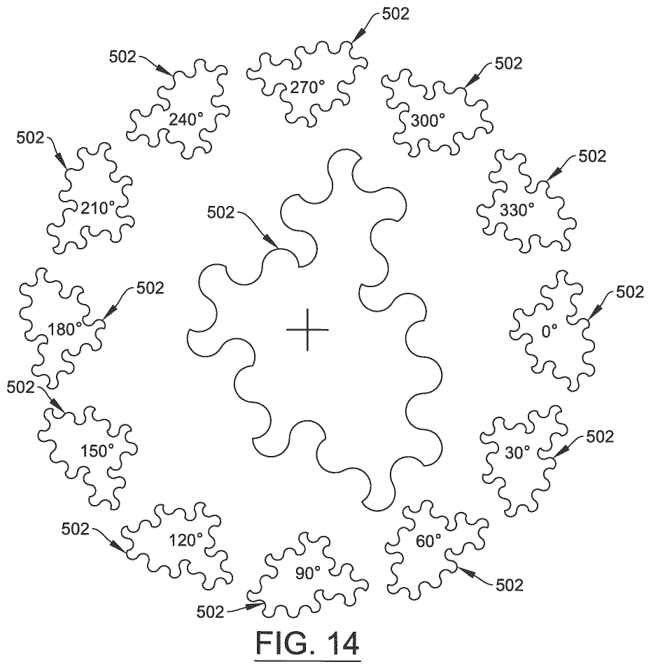

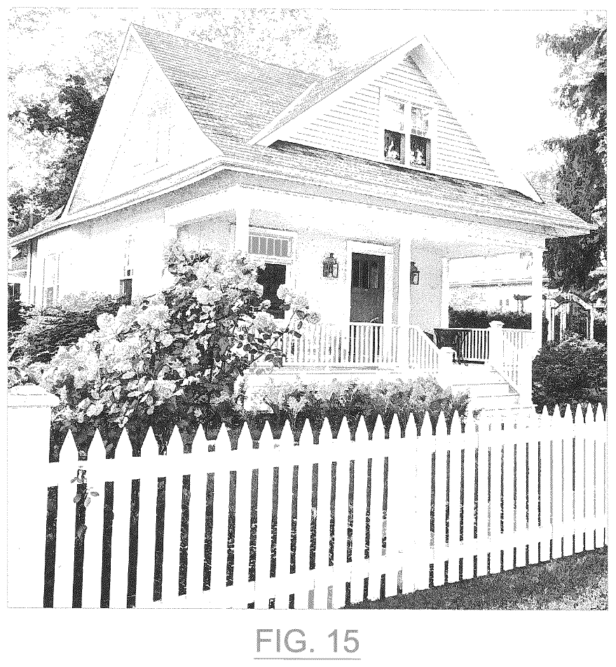

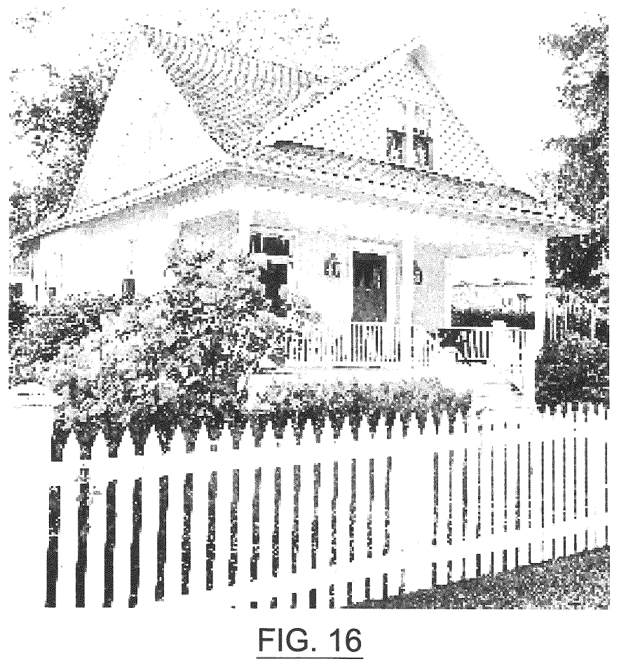

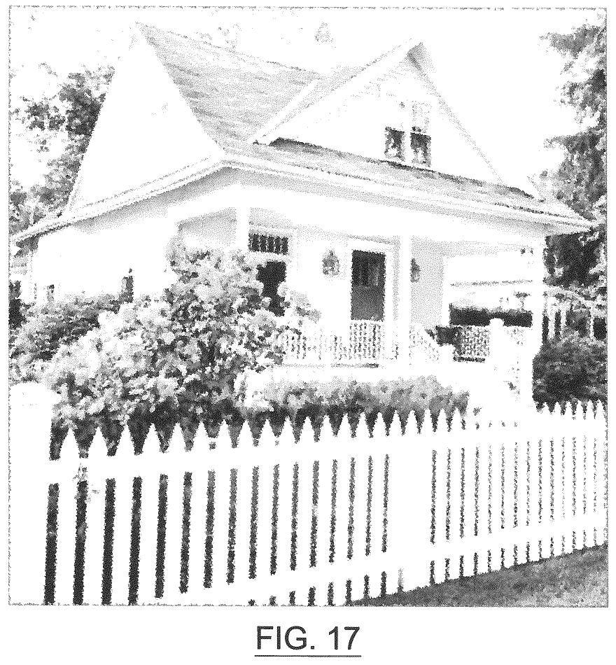

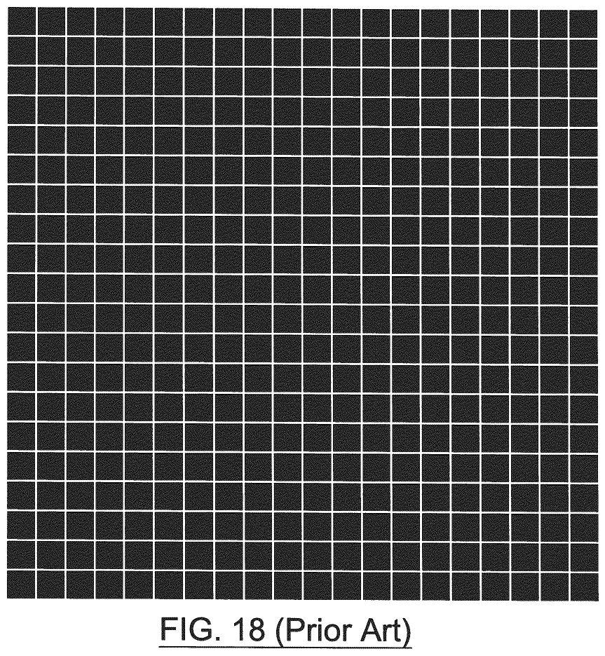

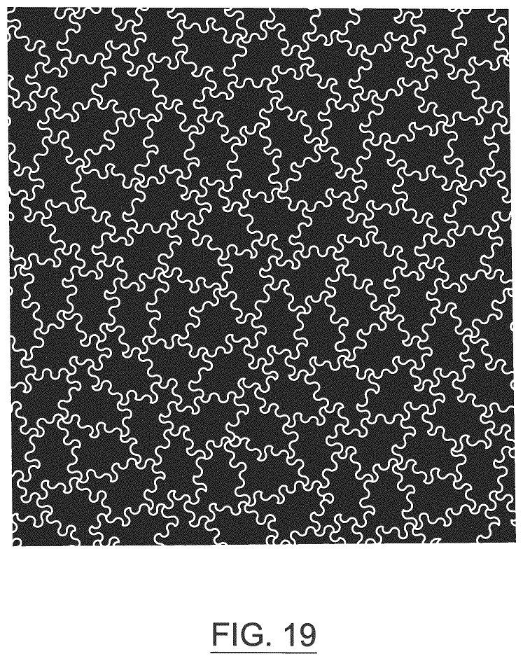

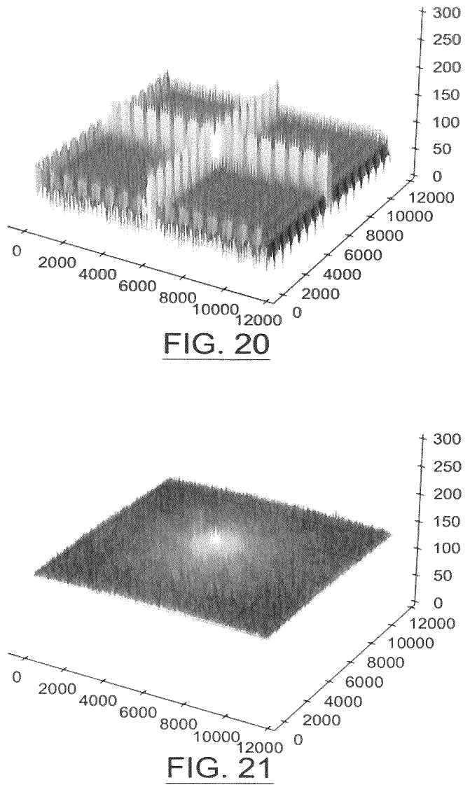

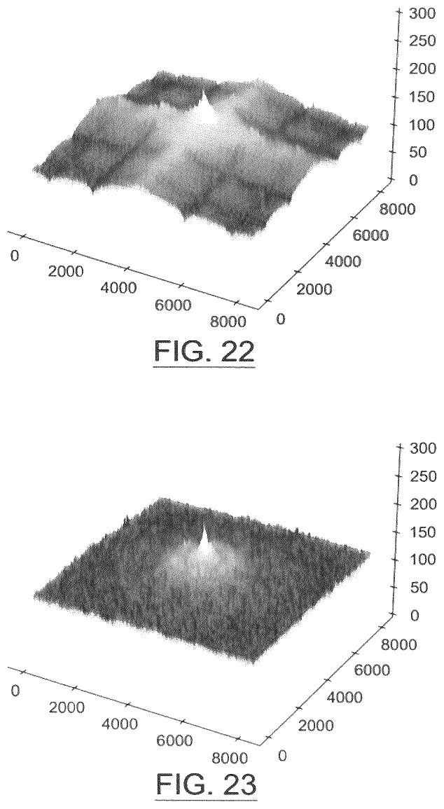

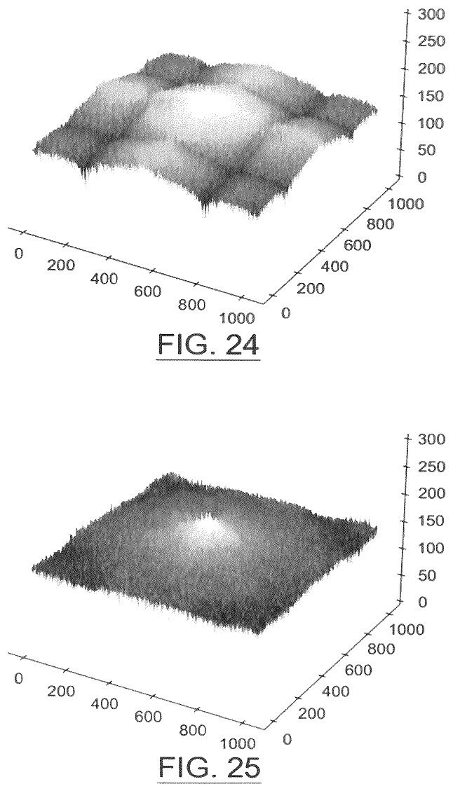

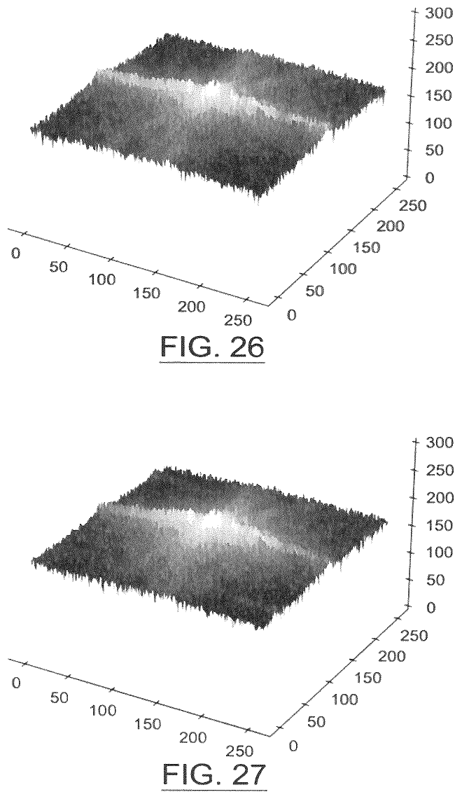

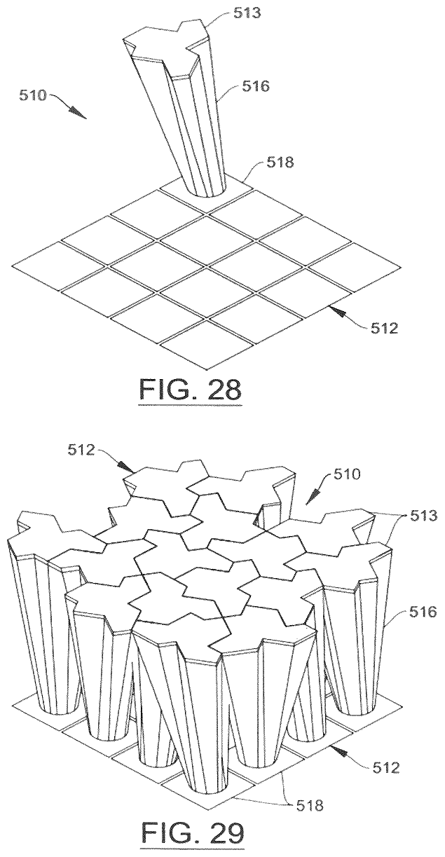

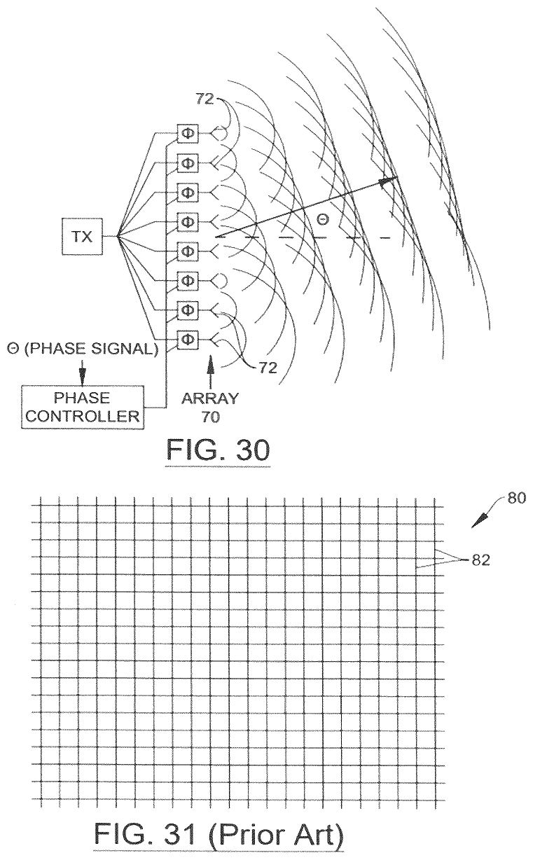

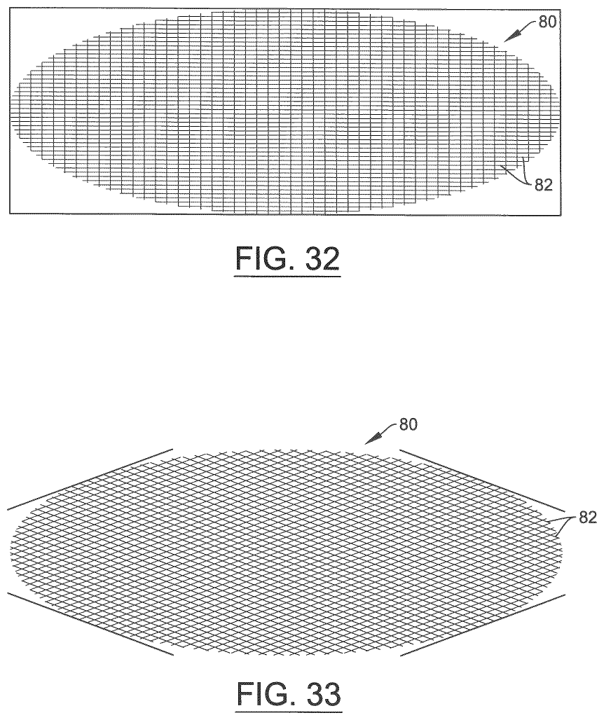

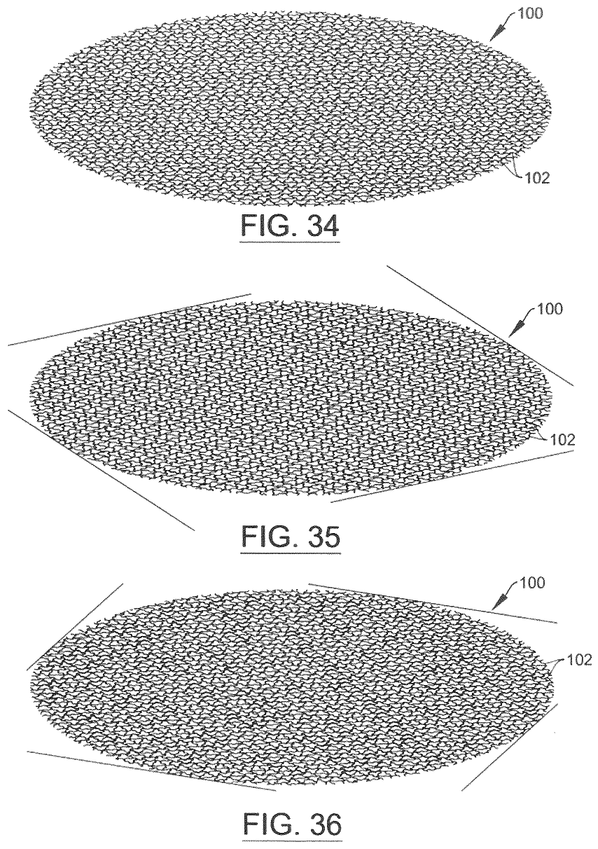

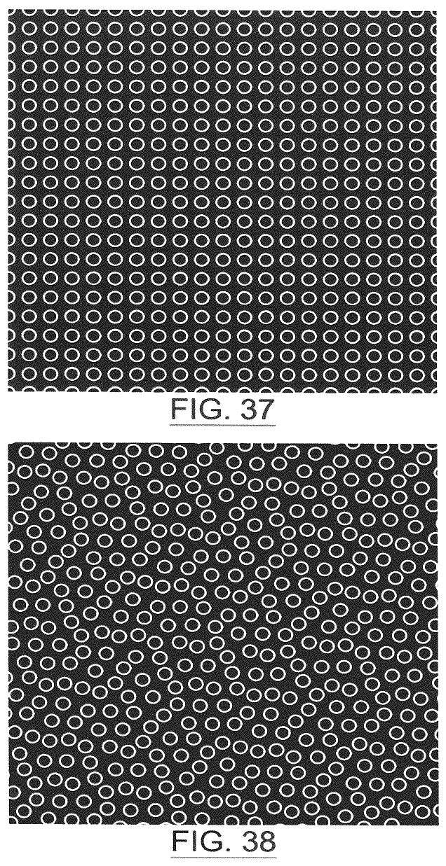

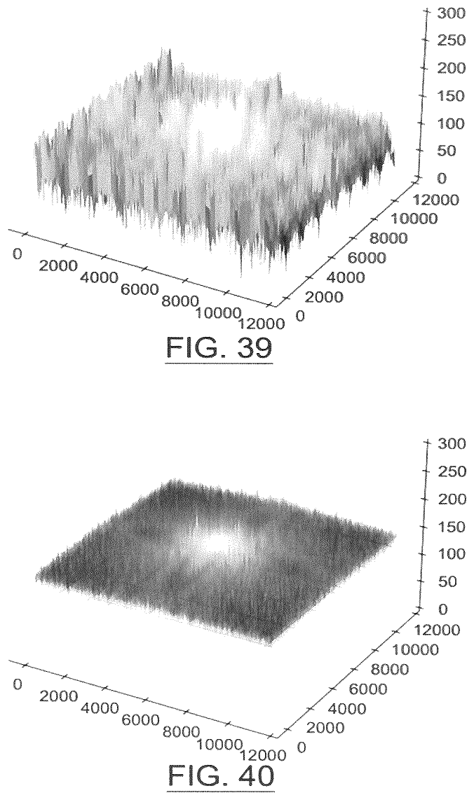

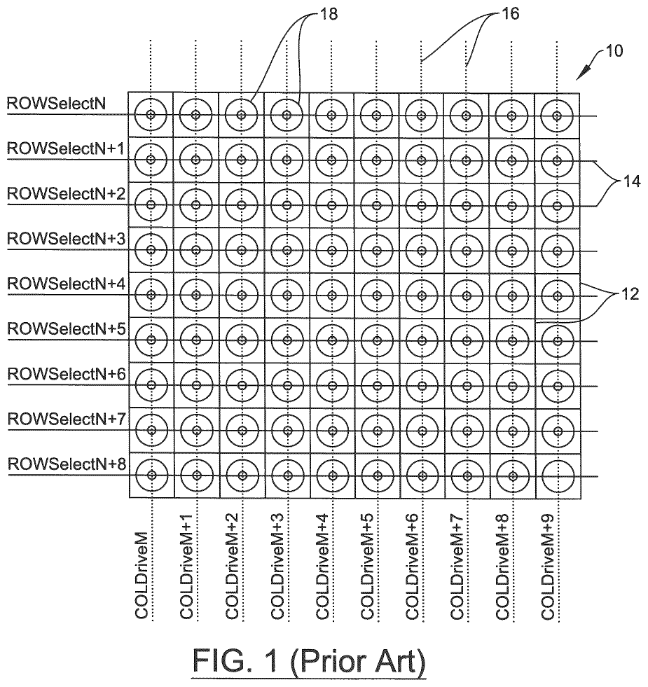

A conventional (prior art) array 10 of electrically addressable elements 12 is illustrated diagrammatically in FIG. 1. An example aperiodic array 20 of electrically addressable elements 22 is illustrated in FIG. 2. In the context of this description, an array of electrically addressable elements means an array of elements that are electrically addressable in a manner that produces a usable result. For some examples: (i) An array of electrically addressable light sensor elements, in which the individual light sensor elements in the array are addressable electrically, can be used to produce an electric signal that is indicative of light intensities or colors of the light that is incident on the individual light sensor elements in the array, for example, to produce an electric signal that is indicative of an optical image that is projected onto the array; (ii) An array of electrically addressable light modulator elements, in which the individual light modulator elements in the array are addressable electrically, can be used to modulate a beam of light that is incident on the array in a pixelated manner to produce a desired image; (iii) An array of electrically addressable light emitter elements, in which the individual light emitter elements in the array are addressable electrically, can be used to produce a light beam comprised of pixels of various light intensities or colors to produce a desired image; (iv) An array of electrically addressable antenna transmitter elements, in which the individual antenna transmitter elements in the array are addressable electrically to produce radio or radar signals comprising signal components that are individually phase shifted or time delayed in relation to each other, can be used to transmit radio or radar signals at different angles relative to the face of the array; and (v) An array of addressable antenna receiver elements, in which the individual antenna receiver elements of the array are addressable electrically to receive components of a radio or radar signal individually in a manner that allows such individual components to be phase shifted or time delayed in relation to each other, can be used to select and receive radio or radar signals from selected directions. These example arrays of electrically addressable elements are not necessarily exclusive, but are illustrative of electrically addressable elements for which this the description of aperiodic arrays of electrically addressable elements are applicable.

The conventional array 10 in FIG. 1 is illustrated diagrammatically in FIG. 1 as a 9×10 array of individual square electrically addressable elements 12, i.e., with nine (9) rows of the square electrically addressable elements 12 and ten (10) columns of the square electrically addressable elements 12. For convenient comparison in this description, the aperiodic array 20 in FIG. 2 is also illustrated diagrammatically as 9×10 array of individual electrically addressable elements 22. In practice, much larger A×B arrays (A rows and B columns) of elements are typically used than the A=9 and B=10 (i.e., 9×10) diagrammatic illustration in FIG. 1 and that will be used for aperiodic arrays in accordance with this description. However, persons skilled in the art will understand that the descriptions and concepts of arrays of electrically addressable elements in this description are sufficient for understanding those concepts and principles in application to any practical sized A×B arrays of such elements described herein.

Most conventional arrays of electrically addressable elements have square electrically addressable elements 12 as illustrated in FIG. 1, because squares provide a convenient geometry for positioning the full surface areas of the respective electrically addressable elements 12 immediately adjacent to each other in arrays with no non-element area (other than border lines of minimal width) between the adjacent electrically addressable elements 12 in the array 10 so that the maximum amount of light that is incident on the array 10 can be captured or modulated by the electrically addressable elements 12 of the array 10 in the cases of electrically addressable elements that are light sensors or modulators, or that the maximum cross-sectional area of a beam of light emitted by a light emitter array can be produced as individual pixels of light for high fidelity signal or image production in cases of electrically addressable elements that are light emitters, or that radar signals and returns have higher resolutions and radio transmissions have higher fidelity in the cases of electrically addressable elements that are antenna transmitter or receiver elements. Such placement of elements on a plane or in a space in a manner that covers or occupies the entire area of the plane or space with no uncovered gaps between the elements is sometimes called tiling or tessellation. Arrays of hexagonal electrically addressable elements (not shown) can also be tessellated (tiled) to provide those benefits, although arrays of hexagonal-shaped electrically addressable elements are not used as commonly as arrays of square-shaped electrically addressable elements.

Persons skilled in the art know how to design and manufacture arrays 10 of square (or hexagonal) electrically addressable elements 12 with electric circuitry wherein the individual light sensor elements 12 are individually addressable electronically. For example, as represented diagrammatically in FIG. 1, each of the individual elements 12 in a particular row of the array 10 is connected to a row electric select bus 14 for such row (e.g., ROW SELECT N through ROW SELECT N+8), and each of the individual elements 12 in a particular column of the array 10 is also connected to a column electric drive bus 16 for such column (e.g., COL DRIVE N through COL DRIVE N+9). The circles 18 at each electrically addressable element 12 diagrammatic representations of the electrical connections (interfaces) of the row electric select buses 14 and the column electric drive buses 16 to the electrically addressable elements 12 in the array 10. Again, persons skilled in the art know how to design and manufacture arrays of electrically addressable elements, including the electronic circuitry and interfaces to connect and operate them, so it is not necessary to show or explain such details here.

Any sampling system, whether a sensor where a continuous input is quantized or a modulator where a discrete signal is used to create a continuous output, has physical limitations imposed by its sampling period or resolution. The Nyquist-Shannon sampling theorem, usually abbreviated as the “Nyquist theorem”, details these relationships and is well known in various engineering and scientific fields. For example, an image sensor array with an image focused by a lens to the array must convert the light of the image into an array of discrete pixel values representing the intensity of the light detected at any given pixel. Likewise, a 2D optical modulator (sometimes also called spatial light modulator), with an array of discrete modulator pixels, imposes a pattern on transmitted or reflected light. As mentioned above, almost all such sensor and modulator devices are designed with a regular square or rectangular grid, although a few have opted for hexagons. However, when image features approach the size of the pixels, (e.g., the size of the electrically addressable elements 12 in the array 10) falling outside the Nyquist sample-rate criterion of two samples per feature size, the performance quickly degrades, and aliasing and moiré patterns are created. This effect is easily seen in images with narrow stripes, such as picket fences as will be explained in more detail below, but, even when it is not as visible, it is present for small features. This effect represents a significant limitation on high-performance optical systems such as telescopes, photography, videography, and many others.

Of course, the Nyquist theorem applies to any sampled system, regardless of the period of the samples, but it is almost always applied in systems with regular sampling because irregular systems are difficult to build. As far back as the 1960's, the idea of random sampling to eliminate aliasing and reduce the required sampling frequency was discussed and even implemented for some applications. Random sampling does not bypass the Nyquist-Shannon theorem, but it does make its application statistical in nature. Since the samples are random, some sensor elements will be spaced nearer together and will sense information that would otherwise have been lost, and aliasing, which is a byproduct of regular sampling, can be eliminated in some cases. However, building a random optical image sensor or modulator is impractical since the location of the individual electrically addressable elements, e.g., optical sensor or optical modulator elements (pixels), on an optical chip are fixed.

The example conventional array 10 in FIG. 1 with its square-shaped electrically addressable elements 12 all arranged in rows and columns illustrates at least some of the benefits of such an array. For example, by providing a row select bus 14 running through each row of electrically addressable elements 12 and running a column drive bus 16 through each column of electrically addressable elements 12, a particular electrically addressable element 12 in the array 10 can be addressed individually by turning on the particular row select bus 14 and the particular column drive bus 16 that are connected to that particular electrically selectable element 12. Again, as mentioned above, persons skilled in the art know how to design, fabricate, and operate such arrays. Further, as also explained above, the example conventional array 10 has no gaps between the adjacent square-shaped electrically addressable elements 12.

However, in addition to the physical limitations imposed by the sampling period or resolution in accordance with the Nyquist theorem as explained above, the regularity of the square-shaped electrically addressable elements 12 in the example conventional array 10 provides a periodic pattern of the electrically addressable elements, thus a periodic pattern of the pixels of light sensed, modulated, or emitted by such electrically addressable elements 12. A tiling (set of tessellated tiles) is periodic geometrically when the tiling is made of a pattern that repeats at regular intervals (periods). If the tiling is made of a pattern that does not repeat at regular intervals, it is non-periodic. Accordingly, an array (ordered set) of electrically addressable elements is periodic if the array is made of the same pattern that repeats at regular intervals (periods), and a pixel pattern associated with such a periodic array is periodic. Such periodicity produces periodic artifacts, such as aliasing or moiré patterns in sensed, modulated, or emitted images. In many common image sensing applications, for example, photography, image recognition, image processing, and remote sensing, such periodic artifacts appear in the sensed or modulated image when a sensor or modulator pattern repeats within an eight to ten pixel spacing. In phased array antennas, periodic artifacts from repetitious or periodic pattern of antenna transmitter or receiver elements include sidelobes on either side of the main beam lobe, grating lobes, and other periodic artifacts that are detrimental to fidelity and resolution of radar returns and radio transmissions. The regularity of hexagonal-shaped electrically addressable elements in an array have the same limitations and disadvantages due to periodicity as the example conventional array 10 illustrated in FIG. 1.

There have been several attempts to make aperiodic device arrays, for example, using elements in the shapes of Schlottman tiles for antennas to address the problems of grating lobes, sidelobes and other periodic effects of conventional antenna arrays, and using elements in the shapes of Penrose tiles to address the detrimental effects of periodicity described above, e.g., aliasing or moiré patterns. However, such Schlottman tiling and Penrose tiling require two or more different shapes to achieve tessellation, i.e., to fit together closely enough without gaps, to address the Nyquist theorem limitations for resolution and efficiency. The necessity of supporting the two or more different shapes having different areas required in such Schlottman and Penrose tiling systems makes it impractical to provide an array of electrically addressable elements in a chip or integrated circuit due to the variation in the size and spacing of the electrically addressable elements in the array, including, for example, the difficulty in coming up with a practical design for chip structures, electrical circuits, and signal processing systems to accommodate individually electrically addressing each element in such a chip or integrated circuit. Also, for signal processing and practical application of sensed or modulated images or data, pixels of light collected from different sized and spaced individual sensor or modulator elements would be impractical.

In contrast, each of the identical electrically addressable elements 22 in the example aperiodic light sensor array 20 illustrated in FIG. 2 has a shape such that each of the electrically addressable elements 22 fits neatly together with adjacent electrically addressable elements 22 with no gaps (other than border lines of minimal width) between them, i.e., that are tessellated (tiled), to provide an aperiodic array 20 of the electrically addressable elements 22, and all of the electrically addressable elements 22 in the array 20 are arranged in rows and columns with each of the light sensor elements 22 in the aperiodic array 20 being connected to a row electric bus 24 and to a column electric bus 26. The “no gaps” in this context means practically no gaps, recognizing that there has to be border lines between adjacent individual electrically addressable elements 22 that isolate the adjacent individual elements 22 physically and electrically from each other, as will be understood by persons skilled in art. Accordingly, the example aperiodic array 20 provides the benefits of aperiodicity for minimizing or avoiding the adverse effects of periodicity, e.g., aliasing or moiré patterns in sensed, modulated, or emitted images, and sidelobes, grating lobes, and other periodic artifacts in transmitted and received radio and radar transmissions.

The term “aperiodic” as applied to tiling is a well-defined term of art by persons who study and publish findings on aperiodic tiling and tile shapes or types (prototiles) that can provide aperiodic tiling. Persons skilled in that field define and understand a tiling to be aperiodic if its hull contains only non-periodic tilings. In other words, an aperiodic tiling is a non-periodic tiling with the additional property that it does not contain arbitrarily large periodic regions or patches. There is no non-zero spatial shift of an aperiodic tiling pattern in relation to a point that leaves the tiling pattern fixed in relation to the point. Further, a set of tile-types (or prototiles) is aperiodic if copies of these tiles can form only non-periodic tilings. In plane geometry, the “einstein problem” asks about the existence of a single prototile that by itself forms an aperiodic set of prototiles, that is, a shape that can tessellate space but only in a nonperiodic way. Such a shape is called an “einstein,” which is a word play on “ein stein”, German for “one stone.” Therefore, a shape is not an “einstein” if it can tessellate a space in a periodic way. Accordingly, a tile (prototile) is not aperiodic and does not meet the definition of an “einstein” tile if it and replicas of itself can tile a space in a periodic manner. It may also be noted in this regard, that there exists an aperiodic tiling, known as a Van Dongen tiling, consisting of prototiles that are all of a single isosceles right triangle shape and in which the triangle prototiles are arranged in rows and columns, but the triangle prototile itself can also tile periodically. Therefore, the Van Dongen isosceles right triangle prototile is not a solution to the einstein problem and is not itself aperiodic.

Accordingly, for purposes of this description, electrically addressable elements in an array that have an einstein shape as explained above are called “einstein electrically addressable elements” or sometimes “aperiodic electrically addressable elements” in accordance with the explanation above for einstein tiles wherein only tiles with an einstein shape are considered to be aperiodic. Also, for purposes of this description, arrays of such einstein electrically addressable elements are called aperiodic arrays.

Applying those tiling principles and definitions to arrays of electrically addressable elements, the example array 20 of electrically addressable elements 22 is aperiodic, and the individual electrically addressable elements 22 have an einstein shape and are aperiodic, because they cannot tile, i.e., tessellate, a space in a periodic manner. The circles 28 at each electrically addressable element 22 in the aperiodic array 20 represent the electrical connections (interfaces) of the row electric buses 24 and the column electric buses 26 to the electrically addressable elements 22 in the array 20. As mentioned above, persons skilled in the art know how to design, fabricate, and operate conventional arrays 10 as illustrated diagrammatically in FIG. 1 with the electric connections or interfaces 18 to the square electrically addressable elements 12 in such arrays, and the same or similar techniques and materials can be used to make the connections or interfaces 28 in the aperiodic light sensor array 20 in FIG. 2. It may be noted that the row electric buses 24 and the column electric buses 28 illustrated in FIG. 2 are not straight line buses in the same manner as the straight line row electric buses 14 and column electric buses 16 in the conventional array 10 in FIG. 1, but they do illustrate that an A×B array of the einstein electrically addressable elements 22 (e.g., the 9×10 array 20 in FIG. 2) can be connected by row electric buses 24 and column electric buses 26 in a 1:1 correspondence with the row electric buses 12 and the column electric buses 14 with the square electrically addressable elements 12 in a same-sized A×B array of square shaped electrically addressable elements 12 (e.g., the 9×10 array 10 in FIG. 1).

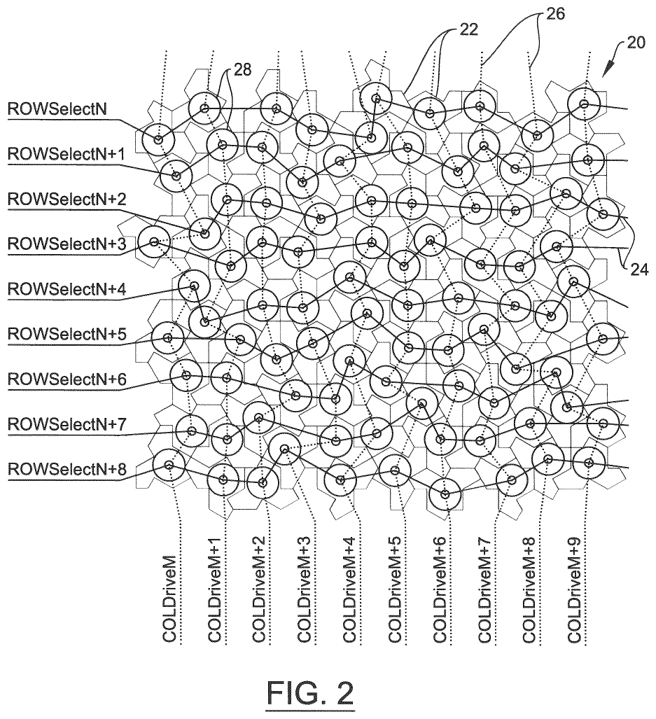

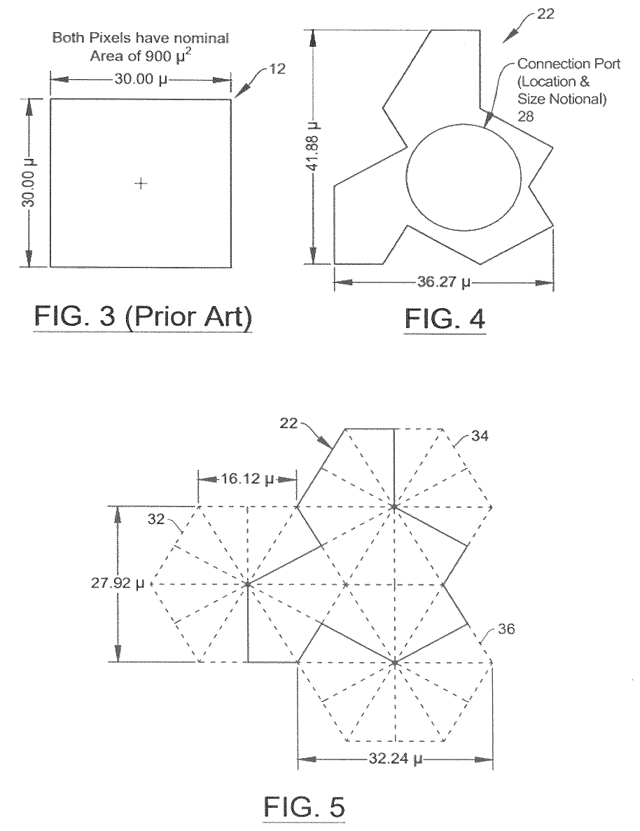

It may also be noted in this regard that, if an aperiodic A×B array (e.g., the 9×10 aperiodic array 20 in FIG. 2) of the aperiodic (einstein) electrically addressable elements 22 in FIG. 2 has the following characteristics as compared to the periodic array 10 of square electrically addressable elements 12 in FIG. 1: (i) the aperiodic array 20 of FIG. 2 has the same overall aperiodic A×B array 20 surface area as the overall surface area of the same sized periodic A×B array of square electrically addressable elements 12 in the periodic array 10 (i.e., A=9 and B=10 in both arrays 10 and 20); (ii) the aperiodic array 20 has the same number of electronically addressable elements 22 as the number of square electronically addressable elements 12 in the periodic array 10; (iii) the individual square electrically addressable elements 12 in the periodic array 10 are all of the same size as each other; and (iv) the individual aperiodic (einstein) electrically addressable elements 22 in the aperiodic array 20 are all the same size as each other; then the individual aperiodic (einstein) electrically addressable elements 22 will have precisely the same surface area as the individual square electronically addressable elements 12, as illustrated in FIGS. 3 and 4. Consequently, each pixel of light detected, modulated, or emitted by the aperiodic (einstein) electronically addressable elements 22 will be detected, modulated, or emitted by the same size in area, albeit not the same shape, as the square shaped sensors 12. Accordingly, the mean resolution of both of the illustrated periodic array 10 (FIG. 1) and the aperiodic array 20 (FIG. 2) of the same overall array area and the same A×B array size will be the same. However, the pattern of square light sensor elements 12, thus pixels of detected, modulated, or emitted light, in the array 10 is periodic, whereas the pattern of aperiodic (einstein) elements 22, thus pixels of detected, modulated, or emitted light, in the aperiodic array 20 is aperiodic, which provides the substantial benefits of a random system, e.g., aliasing is virtually eliminated, and the Nyquist sampling frequency can be reduced for the same performance or made the same for enhanced performance in imaging systems, and sidelobes, grating lobes, and other periodic artifacts can be virtually eliminated for antenna systems. As also explained above, the individual aperiodic (einstein) electrically addressable elements 22 provide accommodate chip architectures can include rows and columns of such individual aperiodic electrically addressable elements that can be designed, fabricated, connected electronically, and operated with conventional, well-known techniques.

Software and hardware can treat the data from either the example conventional array 10 with the square electronically addressable elements 12 or the aperiodic array 20 of einstein electrically addressable elements 22 the same, since the shape of the tiles is irrelevant for purposes of image information handling. As mentioned above, each einstein electronically addressable element 22 in the aperiodic array 20 has exactly the same number and topology relative to its neighbors as the square electronically addressable elements 12 in the conventional array 10. The only additional complexity, from a design standpoint, is that the chip layout needs to accommodate the rotation and position of each einstein electronically addressable element 22. In many cases, the underlying electronics can be built as square elements and only the exposed portion, comprising the sensors, modulators, emitters, or antenna elements, need be aperiodic. In such cases, the square electronic “site” would simply connect to the superimposed nearest einstein electronically addressable sensor, modulator, emitter, or antenna element. The round port 28 at each einstein electronically addressable element 22 is notional and will normalize the bus connections, since it can be designed for a standard orientation. As shown in FIG. 2 and as will be explained in more detail below, there are only twelve rotations of the einstein electronically addressable elements 22, each having a mirrored twin for a total of twenty-four, so common design tools can easily handle the complexity.

Another important advantage of an aperiodic array of einstein electrically addressable elements over a periodic array of square or hexagonal electrically addressable elements is the lack of directional bias. An aperiodic array of einstein electrically addressable elements is truly isotropic or omnidirectional. An aperiodic array of square electronically addressable elements has severe directional bias, since features that lie on a diagonal are effectively sampled by such an array at about seventy percent (70%) of the resolution of features on the orthogonal axis. Therefore, similar features with different orientations are never equally represented, which leads to lower performance in may applications. Accordingly, the Nyquist sampling limitations arise sooner on diagonal features in an image.

Devices with periodic arrays of hexagonal-shaped electrically addressable elements are more isotropic than devices with periodic arrays of square electrically addressable elements, because the directional bias of periodic arrays of hexagonal-shaped electrically addressable elements is smaller than periodic arrays of square electrically addressable elements. In fact, any array other than an aperiodic array will have some inbuilt bias.

Even aperiodic arrays of non-aperiodic electrically addressable elements can have inbuilt bias. For example, as mentioned briefly above, an aperiodic tiling can be made with an isosceles right triangle, e.g., the Van Dongen tiling, but the triangle tile itself is not aperiodic because it can also tile periodically. An aperiodic array of such triangle-shaped electrically addressable elements would exhibit three directions with strong patterning, thus would not be isotropic or omnidirectional.

On the other hand, an aperiodic array of einstein electrically addressable elements has equal representation in all directions, thus is omnidirectional, also called isotropic. It has no uniform grid bias, because it has no uniform grid. A feature oriented at zero degrees) (0° will have precisely the same representation as the same feature at 44°, 45°, or 46° or any other orientation.

One example aperiodic (einstein) electrically addressable element for a truly isotropic (omnidirectional) aperiodic array is the 13-sided polygon shape of the electrically addressable element 22 of the example aperiodic light sensor array 20 illustrated in FIG. 2. That example 13-sided einstein electrically addressable element 22 is illustrated in FIG. 5 in the context of three hexagons 32, 34, 36 from which its 13-sided einstein shape can be created. The 13-sided polygon shape of the einstein electrically addressable element 22 as shown in FIG. 5 enables tiling a plurality of the einstein electrically addressable elements 22 of the same 13-sided polygonal shape and size, i.e., arranging the identically shaped and sized light sensor elements 22 together in a way that they completely cover an area, e.g., an array 20 area, without overlapping and no gaps between them (other than border lines as explained above). The example 13-sided polygonal shape of the einstein electrically addressable elements 22 is based on a composite of sixteen equal right triangular sectors taken from three equal sized hexagons, each of which hexagons is divided into twelve equal angled sectors, as illustrated in FIG. 5. The dimensions illustrated are purely notional; the same shape design could be made and used in different scales.

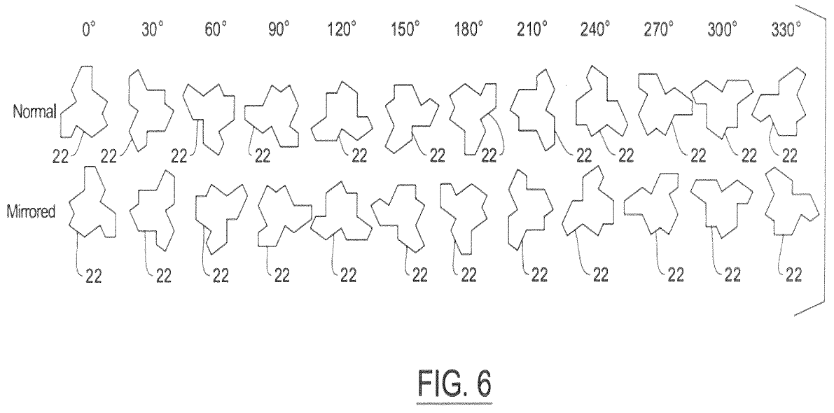

As shown in FIG. 6, the 13-sided einstein electrically addressable elements 22 can be placed in twelve rotational orientations, i.e., 0°, 30°, 60°, 90°, 120°, 150°, 180°, 210°, 240°, 270°, 300°, 330°, each of which is also mirrored for a total of twenty-four differently oriented placements in the array 20 and still tile together, i.e., tessellate a space, with no overlap and no gaps between them. Therefore, the 13-sided einstein electrically addressable elements 22 shown in FIGS. 2 and 4-6 can be tiled in an array 20 with sensor surface area coverage of practically 100 percent, but with an aperiodic pattern. Since this aperiodic array 20 has only twenty-four differently oriented placements of the same sized 13-sided einstein electrically addressable elements 22, some of the oriented placements in the array will be the same, and small sections of the einstein electrically addressable elements 22 may be repeated in the array 20, but not periodically. Beyond a limited local frame, the pattern will never repeat no matter how large the surface area of the array 20. Even a relatively small, e.g., 256×256, array of einstein electrically addressable elements 22 has enough aperiodicity to perform well in optical applications, as will be explained in more detail below.

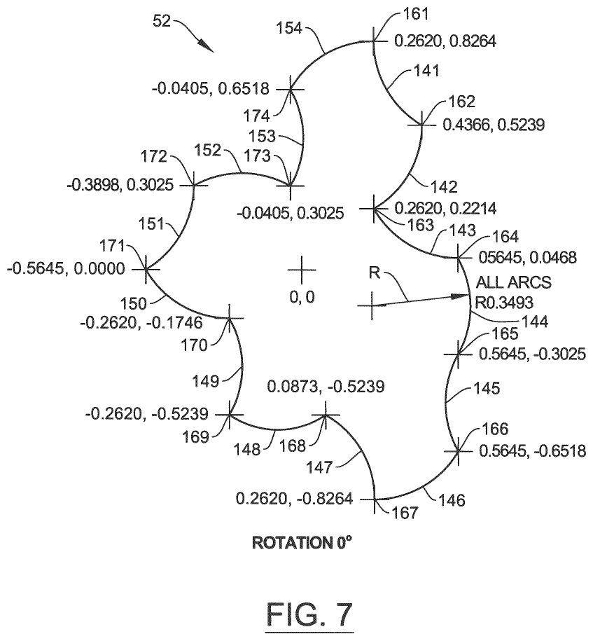

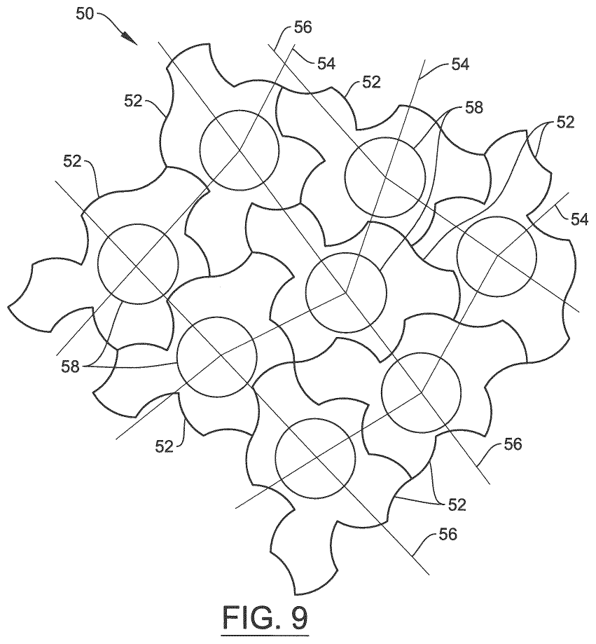

While it is desirable to have an aperiodic array of electrically addressable elements that is truly isotropic, and aperiodic arrays of einstein electrically addressable elements have very good isotropicity, not all aperiodic arrays of einstein electrically addressable elements, including the aperiodic array 20 of the 13-sided einstein electrically addressable elements 22, are completely isotropic. A perfect shape for isotropicity would be a circle, but circles cannot tessellate a space or area, i.e., would not fit together closely enough without gaps to address the Nyquist theorem limitations for resolution and efficiency. However, it is possible to provide an einstein electrically addressable element that duplicates the edge curvature of a circle and even decouple the element area from the area of a circle of equivalent radius. An example of such an einstein electrically addressable element 52 is illustrated in FIG. 7, which has fourteen (14) side segments 141, 142, 143, 144, 145, 146, 147, 148, 149, 150, 151, 152, 153, 154 with alternating concave and convex curvatures that, if composited together, would complete a circle, i.e., a “pseudo-circle”, as will be explained in more detail below. This curve-sided einstein electrically addressable element 52 can tessellate an area, as illustrated by the partial array 50 in FIG. 9, and it is aperiodic.

Another important aspect of the curve-sided electrically addressable element 52 for many applications is its isotropicity. For any array of multiple electrically addressable elements used to either modulate (transmit) or sense (receive) a signal of any type, e.g., optical, RF, or sound, the Fourier transform of the edges of the electrically addressable elements in the array is superimposed on the signal. Repetitions of particular differently oriented edges cause beat patterns in the Fourier transform, e.g., grating lobes, and other noise artifacts. The more repetitions of such different edge orientations in an array, the noisier will be the signals either received or transmitted by the array. Conversely, the fewer of such different edge orientations in an array, the less noisy will be the signals either received or transmitted by the array. If there are no repeated, consistent patterns of edges, in the array, then the Fourier transform of the received or transmitted signal will have minimal noise. In this regard, a circle looks the same from every direction, and multiple circles with the same radius look the same from every direction. Advantageously, the einstein electrically addressable elements 52, with their fourteen (14) curved side segments 141, 142, 143, 144, 145, 146, 147, 148, 149, 150, 151, 152, 153, 154 can be made to look like a circle to a signal, i.e., a “pseudo-circle,” as will be explained in more detail below, thus effectively making the orientation of all the side segment edges exactly the same, i.e., circular edges, from every direction.

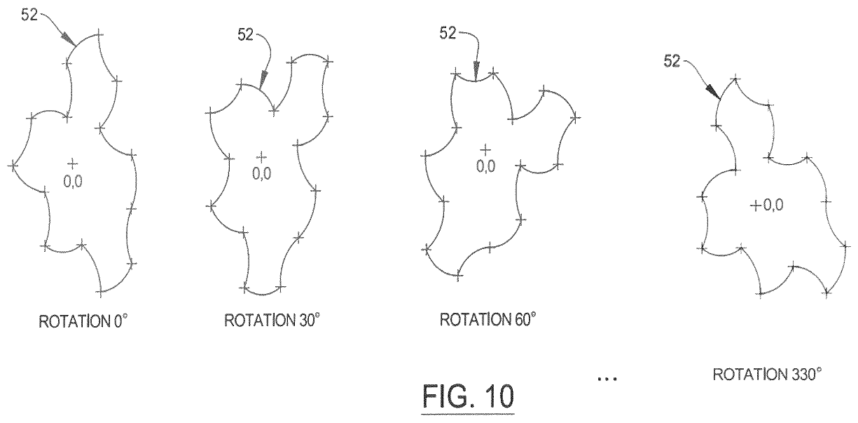

As mentioned above, the einstein electrically addressable element 52, with its fourteen (14) curved side segments 141, 142, 143, 144, 145, 146, 147, 148, 149, 150, 151, 152, 153, 154 can tessellate space, as illustrated by the partial array 50 in FIG. 9. For a full array, the einstein electrically addressable elements 52 can be tessellated with twelve (12) rotational orientations of the elements 52, e.g., 0°, 30°, 60°, 90°, 120°, 150°, 180°, 210°, 240°, 270°, 300°, 330°, as illustrated in FIG. 10. Reflections are not required.

Referring now primary to FIG. 7, the points of transitions from concave to convex are the end points 161, 162, 163, 164, 165, 166, 167, 168, 169, 170, 171, 172, 173, 174 of the respective side segments 141, 142, 143, 144, 145, 146, 147, 148, 149, 150, 151, 152, 153, 154. For example, the side segment 144 has end points 164, 165, and the adjacent side segment 145 has end points 165, 166. All of the fourteen (14) side segments 141, 142, 143, 144, 145, 146, 147, 148, 149, 150, 151, 152, 153, 154 are equal in length, and each of the fourteen (14) side segments has a mirror partner with the same orientation. Therefore, by making curvatures of all the side segments arcs of a circle, all with a radius R that is less than or equal to the straight-line distance between the end points of the side segments, a full “pseudo-circle” can be created as a composite of the arcs of the side segments, which makes the einstein electrically addressable element 52 truly isotropic.

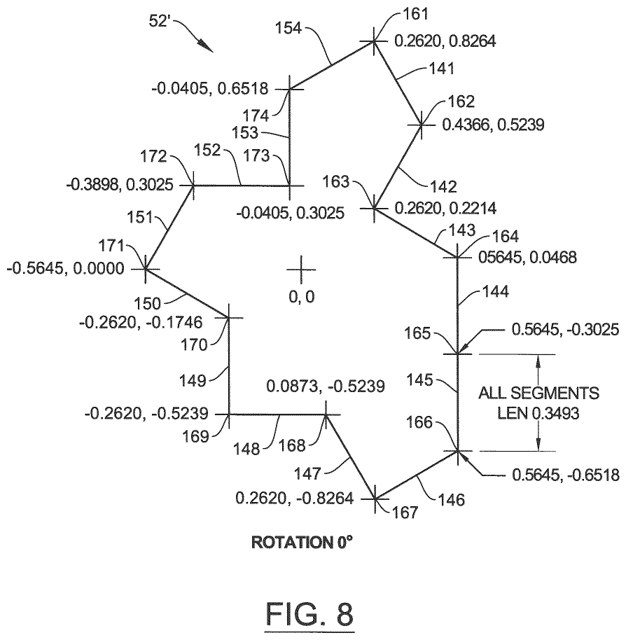

However, if the radius R of curvature of the side segments is greater than the straight-line distance between the end points of the side segments, angular gaps in the composite of arcs occur, i.e., angular gaps in the circumference of the “pseudo-circle”, so an array of such electrically addressable elements would not be truly isotropic. The larger the radius R is made, the larger the angular gaps in the “pseudo-circle” will be, and the less isotropic an array of such electronically addressable elements will be. If the radius R approaches infinity, i.e., the curvature of the side segments 141, 142, 143, 144, 145, 146, 147, 148, 149, 150, 151, 152, 153, 154 disappears, the side segments will be straight lines, as illustrated by the einstein electrically addressable element 52′ in FIG. 8. While the straight-sided einstein electrically addressable element 52′ is aperiodic, an array of such straight-sided einstein electronically addressable elements 52′ is not fully isotropic for the reasons explained above.

The area of the einstein electrically addressable element 52 in FIG. 7 depends only on the straight-line distance between the end points of the respective side segments 141, 142, 143, 144, 145, 146, 147, 148, 149, 150, 151, 152, 153, 154, which, as explained above, are all equal. Whatever area the concave side segments 141, 143, 145, 147, 149, 151, 153 subtract from the area, the convex side segments 142, 144, 146, 148, 150, 152, 154 add. Accordingly, since the straight-line distance between the side segment end points of both the curve-sided einstein electrically addressable element 52 illustrated in FIG. 7 and the straight-sided einstein electrically addressable element 52′ illustrated in FIG. 8, the areas of those illustrated versions of einstein electrically addressable elements are the same. This characteristic can also be provided with some more exotic side segment shapes if such shapes are symmetrical.

Accordingly, both the curve-sided einstein electrically addressable elements 52 in FIG. 7 and the straight-sided einstein electrically addressable elements 52′ in FIG. 8 are scalable to any desired size. The x,y values of the segment end points 161, 162, 163, 164, 165, 166, 167, 168, 169, 170, 171, 172, 173, 174 shown for the example curve-sided einstein electrically addressable element 52 in FIG. 7 provide the scale proportions for a unit area of 1.000 to four digits of accuracy, where the center of mass 175 of the example einstein electrically addressable element 52 is the coordinate center 0,0, i.e., at x=0 and y=0. The example straight-sided einstein electrically addressable element 52′ in FIG. 8 is equivalent, i.e., the same area unit of 1.000. Both the curve-sided einstein electrically addressable element 52 and the straight-sided einstein electrically addressable element 52′ are scalable any desired real-world units with those x,y end point values. For example, if the area of the einstein electrically addressable element 52 is 1.0 cm, the end point 161 is at x=0.2620 cm and y=0.8264 cm. If the area is 10 cm, then the end point 161 is at x=2.620 cm y=8.264 cm. It may be noted that the arc radius R in both the example curve-sided einstein electrically addressable element 52 and the example straight-sided einstein electrically addressable element 52′ is equal to the straight-line distance between the end points of the respective side segments. Although making the radius R equal to the straight-line distance between the segment end points is not a required criterion, it does represent an optimum arc curvature (“sweet-spot”) for the curved side segments, since it is the largest radius where a composite 360° circle edge is fully represented in each einstein electrically addressable element 52, 52′. However, for purposes of any kind of signal processing with arrays of electrically addressable elements 52, providing the einstein electrically addressable elements 52 with a radius R that is in a range of ninety-five percent (95%) to one hundred fifteen percent (115%) of the straight-line distance between segment end points will provide good isotropicity along with aperiodicity.

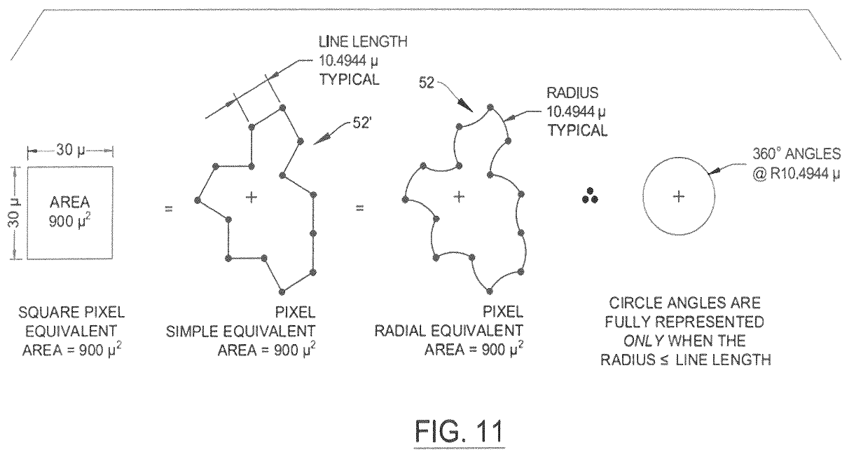

FIG. 11 is a diagrammatic representation of an example design for a curve-sided, aperiodic, einstein electrically addressable element with an area of 900μ², which is an appropriate size for a light sensor element. Based on the x,y relationships for a unit area of 1.000 as shown in FIGS. 7 and 8 and described above, a distance between side segment end points equal to 10.4944μ and a side segment arc radius of 10.4944μ provide a composite of edge curvature that represents a complete 360° circle with no angular gaps. A fully tessellated array will comprise all twelve (12) of the different orientations of the einstein electrically addressable elements 52 shown in FIG. 10 and described above, so the average coverage will be truly isotropic.

It is also appropriate to note that the curve-sided, aperiodic einstein electrically addressable elements 52, when tessellated in an array, are arranged in rows and columns, as illustrated in the partial array 50 in FIG. 9, so that they can be easily connected electronically together and to external electronics. The circles 58 are diagrammatic representations of the connection ports similar to the connection ports 18 and 28 of the respective elements 12 and 22 in FIGS. 1 and 2. Also, example row select buses 54 and column drive buses 56 for connecting the individual aperiodic electrically addressable elements 52 of the array 50 electrically to signal processing, transmitting, or receiving circuits (not shown). Again, persons skilled in the art know how to design, fabricate, and operate arrays of light sensors, light modulators, and antenna transmitter and receiver elements with such connections, so it is not necessary to describe such connection details or structures here.

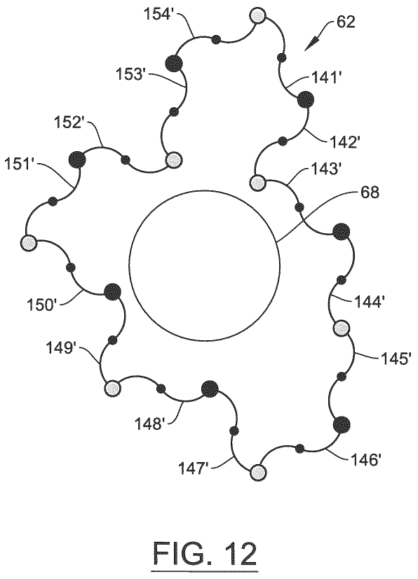

Actually, a variety of symmetrical edge or side contours in addition to the circular arc illustrated by the radius arrow R in FIG. 7 are facilitated by variations of the basic einstein electrically addressable element 52, with the fourteen (14) curved side segments 141, 142, 143, 144, 145, 146, 147, 148, 149, 150, 151, 152, 153, 154 in FIG. 7. Different radius arcs can be optimized for particular applications. Any symmetrical shape, even non-circular, can replace the curved side segments in FIG. 7. As another example, the curve-sided, einstein electrically addressable element 62 illustrated in FIG. 12 has multiple curves in each of the fourteen (14) side segments 141′, 142′, 143′, 144′, 145′, 146′, 147′, 148′, 149′, 150′, 151′, 152′, 153′, 154′. The circle 68 is a diagrammatic representation of electric connections to the curve-sided einstein electrically addressable element 62.

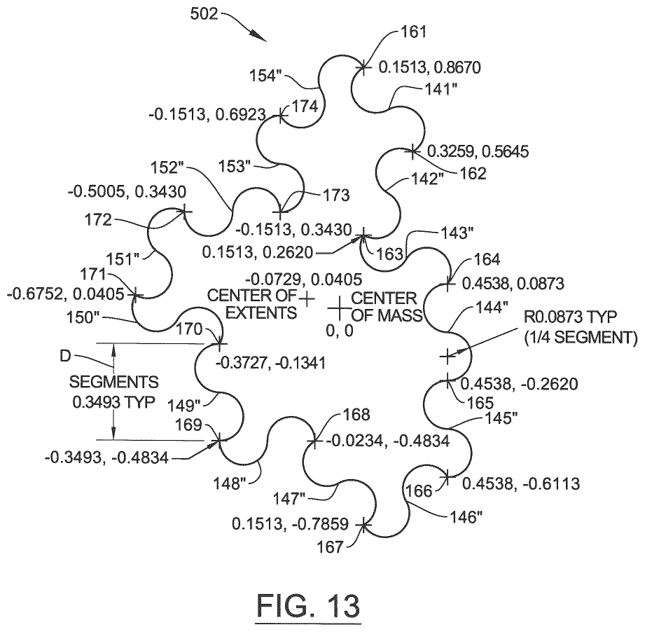

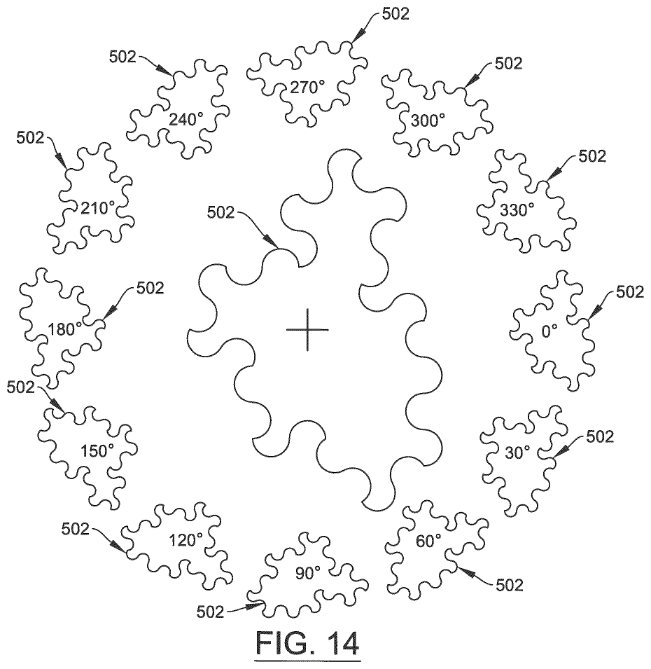

Another example curve-sided, einstein electrically addressable element 502 is illustrated diagrammatically in FIG. 13, wherein each of the fourteen (14) side segments 141″, 142″, 143″, 144″, 145″, 146″, 147″, 148″, 149″, 150″, 151″, 152″, 153″, 154″ is divided into two opposite facing half circles, i.e., oppositely facing semicircles. Each of the fourteen (14) side segments 141″, 142″, 143″, 144″, 145″, 146″, 147″, 148″, 149″, 150″, 151″, 152″, 153″, 154″. This curve-sided einstein electrically addressable element 502 is a variation of the curve-sided einstein electrically addressable element 52 in FIG. 7 in that it also has segment end points 161, 162, 163, 164, 165, 166, 167, 168, 169, 170, 171, 172, 173, 174, and the straight-line distance D between the end points of each side segment is the same for all side segments. Also, like the curve-sided einstein electrically addressable element 52 in FIG. 7, each of the fourteen (14) side segments of the curve-sided einstein electrically addressable element 502 has a mirror partner with the same orientation. Also, like the curve-sided einstein electrically addressable element 52 in FIG. 7, twelve (12) rotations of this the curve-sided einstein electrically addressable element 502, as illustrated in FIG. 14, are available for completely tessellating a space.

The division of each side segment 141″, 142″, 143″, 144″, 145″, 146″, 147″, 148″, 149″, 150″, 151″, 152″, 153″, 154″ into two oppositely facing half-circles, as illustrated in FIG. 13, has the elegant property of representing a complete 360° boundary (edge) direction for each side segment, which guarantees a complete lack of directional bias for every one of the fourteen (14) side segments 141″, 142″, 143″, 144″, 145″, 146″, 147″, 148″, 149″, 150″, 151″, 152″, 153″, 154″.

To provide two half-circles for each side segment 141″, 142″, 143″, 144″, 145″, 146″, 147″, 148″, 149″, 150″, 151″, 152″, 153″, 154″, the radius of each half-circle should ideally be one-fourth of the distance D. A smaller radius would not reach the end points, and a larger radius loses the advantage of complete lack of directional bias as it deviates from the ideal. However, in practice, a half-circle with a radius in a range of 0.25×D to 0.275×D will provide a sufficient avoidance of directional bias to be useful for many applications.

As another variation, each of the half-circles of a side segment could be replaced with two quarter-circles or with four eighth-circles. In fact, any even number of fractions of circles providing up to 180° arcs could be used in place of the half-circles.

Aperiodicity has important advantages for sensing and modulation applications as well as for high performance neural nets, as will be explained below. Little, if any, consideration has been given to the problem of periodicity in current digital neural nets, perhaps because there has been no practical digital solution.

An advantage of a sensor array, modulator array, or antenna array made with the einstein electrically addressable elements in FIGS. 2 and 4-14 and described above, instead of square or hexagonal pixels, is a pseudo-random sampling which gives better information at lower resolutions. Aperiodic arrays of such sensors and modulators virtually eliminates aliasing and moiré patterns, since they have no periodic sampling structure which might give rise to an optical beat frequency. Such aperiodic arrays delineate low resolution edges better for the same reason. They also have the advantages of random sampling as explained above, but with the additional advantage of a uniform pixel size and shape. Essentially, a sensor or modulator array comprising the aperiodic einstein electrically addressable elements described above will provide better information than a square-pixel sensor or modulator array with the same pixel size and count. Therefore, image compression can be accomplished with aperiodic imaging, since better image quality is obtained with the same number of pixels or the same image quality with fewer pixels. Hexagonal pixel devices are better than square-pixel devices simply because their uniform directional bias is smaller, but it is still present. In fact, any pixel array except for aperiodic will have an inbuilt bias.

On the other hand, any device comprising an aperiodic array of electrically addressable elements as described above has approximately equal representation in all directions. Such devices have no uniform grid bias because they have no uniform grid, which is a by-product of aperiodic tiling of the sensor or modulator elements in the array and requires no special effort to achieve. A feature oriented at 0° will have approximately the same representation as the same feature at 45° or at any other orientation.

Bias and structure are types of information noise. The fact that aliasing and moiré patterns are common in square-pixel systems is an indication that the information is somewhat corrupted. This effect is not an indictment of square-pixel systems alone, since all sampled systems have some sort of structure and, therefore, some sort of noise. However, pattern noise is substantially less in aperiodic pixel element systems.

As explained above, both square-pixel sensors or modulators and the aperiodic einstein electrically addressable elements, in which the pixels have precisely the same area, thus have the same mean resolution. As also explained above, the aperiodic einstein electrically addressable element interconnection scheme shown in FIG. 2 is notional and might not be the optimal arrangement, but it does illustrate that there is always a 1:1 correspondence between the square sensor or modulation scheme in FIG. 1 and the aperiodic einstein electrically addressable element scheme in FIG. 2, wherein both represent the same row and column sized and surface area sized arrays (e.g., 9×10 arrays in this example). The round “Port”, e.g., connection interface component 28 at each aperiodic einstein electrically addressable element 22 will normalize the bus 24, 26 connections, since it can be designed for a standard orientation. Also, common design tools known to persons skilled in the art can easily handle the chip and interconnection architectures of arrays comprising the einstein electrically addressable elements described above.

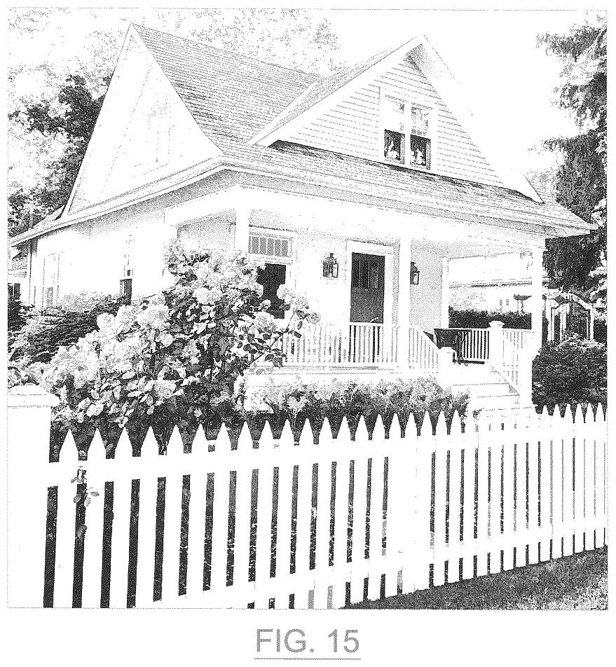

The advantages of the aperiodic sensor array of the aperiodic einstein electrically addressable elements 22 described above were demonstrated with a sensor simulation comparing that aperiodic einstein array to a square sensor array. The physical array systems were simulated by scaling up each simulated square-array to an 84×84 hi-res-pixel (high resolution pixel) representation with the curve-sided einstein elements 502 described above and shown in FIG. 13 to the same area of 7,056 pixels. This scale-up provided a simulated sensor size 256×256 tiles represented as 84×256=21,504 pixels on a side. With padding to make superposition easier, the images are 22,315 pixels. The test image (FIG. 15) is a full 22,315 pixels on a side, which provided an oversample far above the Nyquist sampling criteria, thus plenty of resolution to make certain that major inherent sampling errors were not occurring. The test image was also selected to include a large range of well-defined features, some of which would certainly introduce noticeable aliasing in a 256×256 tile system.

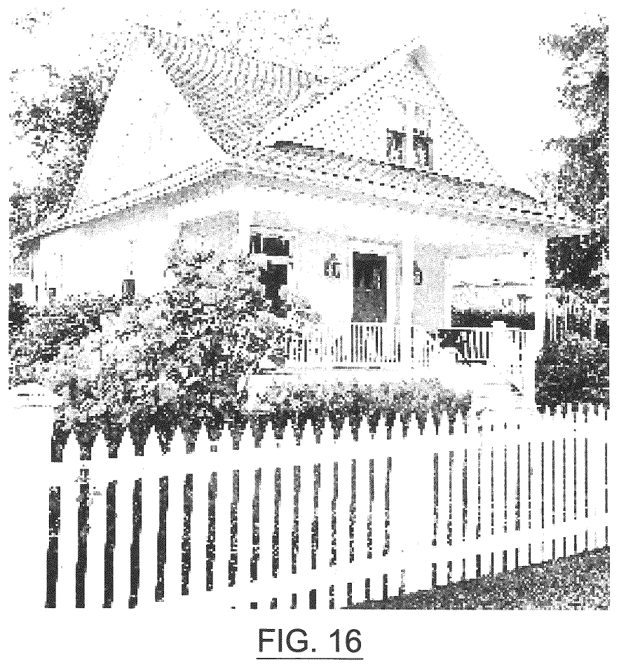

Next, the test image was resampled to a 256×256 resolution without interpolation. In other words, each 84×84 region in the high-resolution test image was averaged to give one square-tile value in the low-resolution result. FIG. 16 is approximately what a 256×256 square-pixel hardware sensor would see. Note that some of the picket fence in FIG. 16 has “merged,” and the roof shingles and siding have largely disappeared into moiré patterns. This effect is typical of sensing artifacts when the Nyquist limits are approached.

Finally, a simulated sensor using the curve-sided einstein tiles was created. Each curved-side einstein tile in the simulation had the same area as the square tiles, and, like before, each of the underlying high-resolution image pixels was averaged to produce the final value for the curve-sided einstein tile. FIG. 17 is approximately what a 256×256 curve-sided aperiodic einstein electrically addressable sensor hardware would see. The differences between this image in FIG. 16 and the image in FIG. 17 are striking. The fence pickets in FIG. 17 are now separated, the roof shingles are discernable, and the siding is delineated. There are no moiré patterns or aliasing in FIG. 17. Straight lines in FIG. 17 are now “dithered,” which is an inherently more robust representation as we approached the limits of our resolution. The curve-sided einstein tile image gives a more usable representation of the picture content, even when it is resolution limited. The siding is visible, the shingles have at least a general shade and direction, and the window reflections are more representative of the reflected trees.

As mentioned several times above, the principles and benefits of the aperiodic einstein electrically addressable element arrays are also generally applicable to modulator arrays as well as sensor arrays. The general benefit of a aperiodic einstein electrically addressable sensor element array was gauged by comparing sensed images with a “real world” image (picture) as explained above and shown in FIGS. 15-17, but modulation is not as easy to characterize or visualize. To get an idea of the benefits of the aperiodic einstein electrically addressable elements for pixel modulation, Fourier Transforms were used because a principal use of such a modulator would be in an optical processing system. Fourier Transforms are commonly used in such systems to extract picture information.

A regular structure like square physical tiles causes a strong pattern to appear in the Fourier plane when the image passes through a lens, which was simulated by applying a Fast Fourier Transform (FFT) to a scaled-up version of the sensor/modulator where each pixel region is represented by many original pixels from a hi-res test image (the same 84×84 pixel-per-tile representation for the square tiles was used, and the same area of 7,056 pixels for the aperiodic einstein electrically addressable elements as used in the sensor simulation described above) to represent the physical structure of the device tiles. Ideally only the image information superimposed by the modulator data would be present in the resulting Fourier Transform. However, since the information is presented, processed, and sensed by physical devices, the tile edges always play a part. Even a specular device made with circular pixels would introduce strong repetitive patterns (with the additional penalty of “dead space” between pixels). Also, in an optical processing system, which uses FTs for convolution, “discontinuities” in the transform represent noise. Every physical tile has edges which contribute to unwanted patterns in the FT. Although the FT is still generally usable, lower noise is always desirable. Accordingly, it is informative to look at a worst-case example that has bright white edges and deep black centers for the tiles.

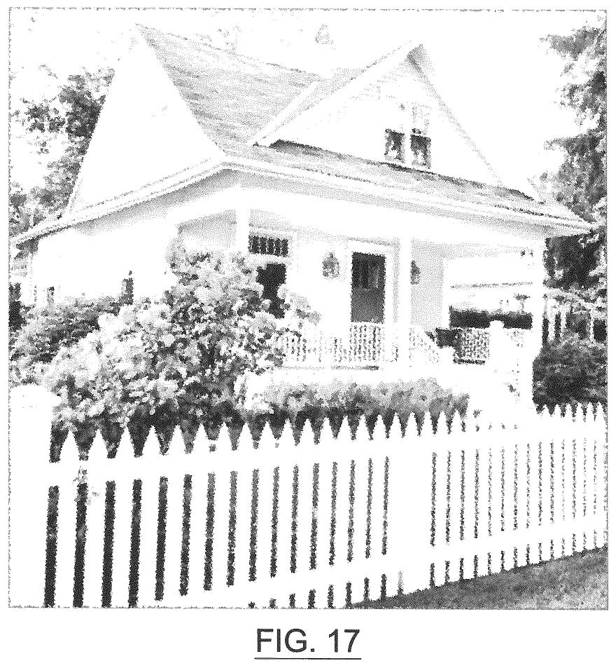

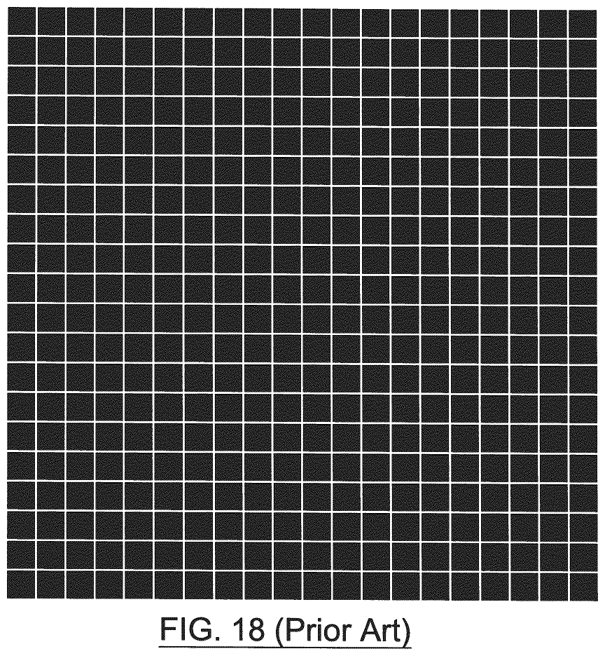

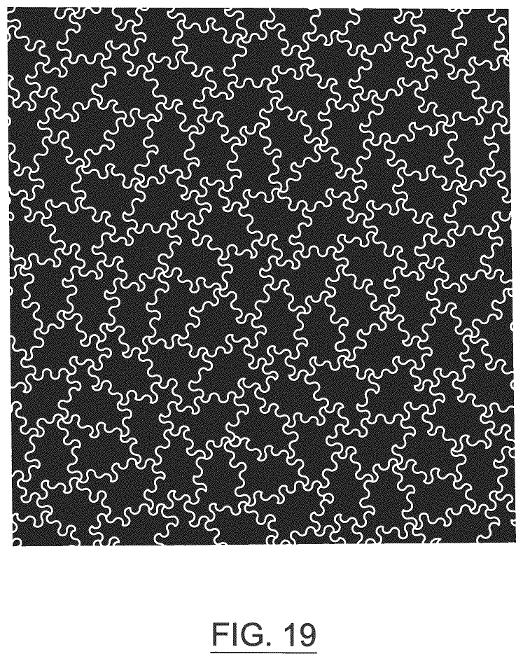

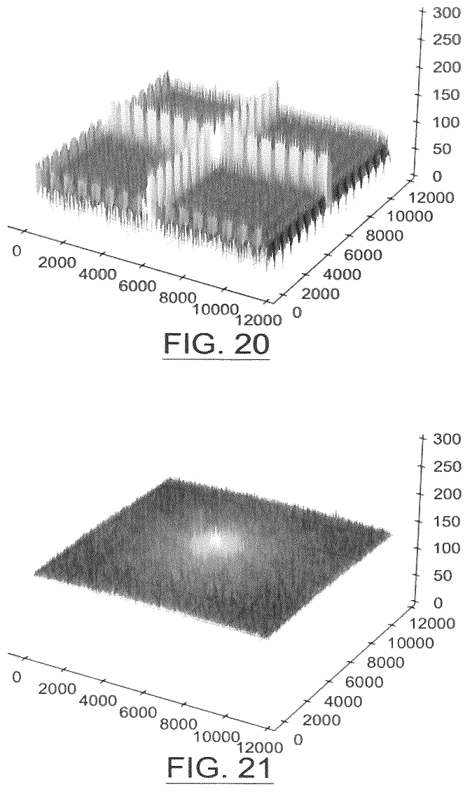

FIGS. 18 and 19 are small cutouts of the actual test images, which are too large to display here at full resolution. However, they show the basic idea of a worst-case high-noise “torture test” with white-edged tiles to show how the tile structure affects the output independent of the picture content. FIG. 20 and FIG. 21 show the respective Fourier Transform results. The FT of the square white-edge tiles shown in FIG. 20 has strong repetitive patterns. In an actual optical or antenna system, the patterns would probably not be so strong since this simulation has every pixel outlined in stark white. But this simulation enables one to see the pattern. The FT of aperiodic, curve-sided einstein white-edge tile image in FIG. 21 is inherently much quieter and looks much like a gaussian distribution around the DC term. There are minor noise artifacts because the curvature of the einstein tiles cannot be perfectly represented by the white and black pixelization. However, since the edges of the tiled einstein tiles do not repeat at any large scale, they no real repetitive patterns. Note that the einstein tiled pixels used in this simulation as shown in FIG. 19 are of the same size, colors, and quantity as the square tiles used to generate FIG. 20. Again, in a real world situation, the noise would presumably be even lower.

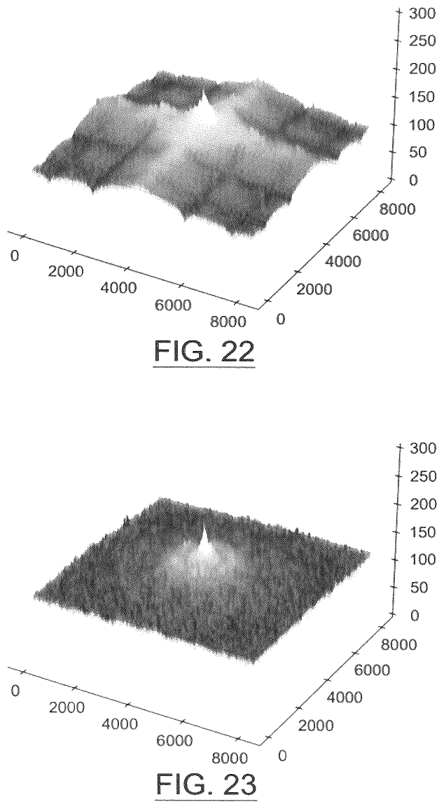

FIGS. 22 through 27 show the Fourier transforms of the house images at various magnifications. To simulate use of an actual image and not making the square-pixel edges white, FIG. 22 is the FT of the square tile house in FIG. 15. Most of the structural feature information representing the house itself is near the center of the data in FIG. 22, but the smaller data, such as the shingles and fence pickets, is further out from the center. However, the tile structure itself is a major part of the transform and is seen in the ridges emanating from the center.

FIG. 23 is the same house at the same resolution but sampled with curve-sided einstein tiles. The structural information of the house is clearly visible in FIG. 23 as the spikes near the center. Significantly, there is almost a complete lack of noise since the curve-edged einstein tiling is aperiodic and isotropic.

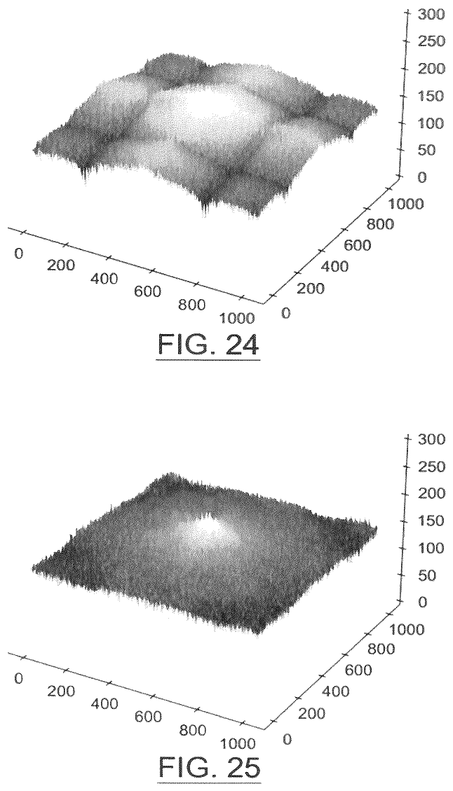

FIG. 24 shows the small center region of the square-pixel FT. The square-tile pattern is still strongly represented, although the structural house information is clearly present. For the goal of identifying objects, this scale is probably the most important scale for such image processing applications.

FIG. 25 shows a FT of the same region as FIG. 24 but using the curve-sided einstein tiles. The structural information for the house in the center is much stronger than the background.

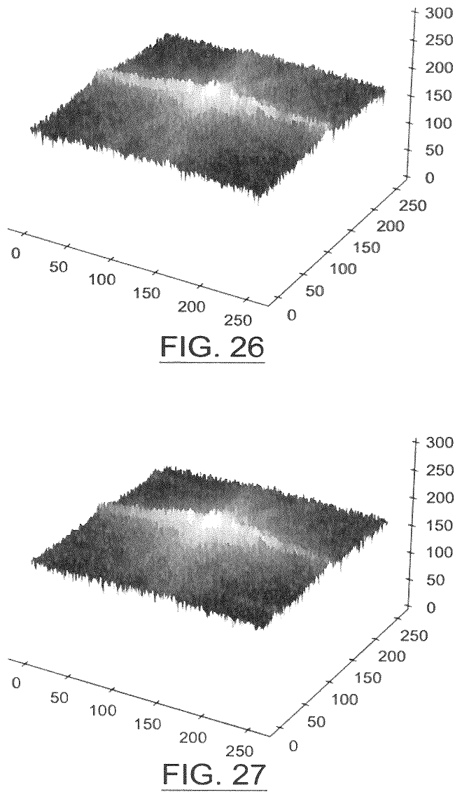

The center of the FT is further magnified in FIG. 26 to only include the largest, strongest house features. This data would not include siding, shingles, tree leaves, etc. Much of the darker portion is still pixel noise, especially noticeable toward the left and right edges of the “central ridge”.

FIG. 27 shows the same FT region as FIG. 26 with curve-sided einstein tiles. The large house features are clearly represented, and, even at this scale, there is far less noise than in FIG. 27.

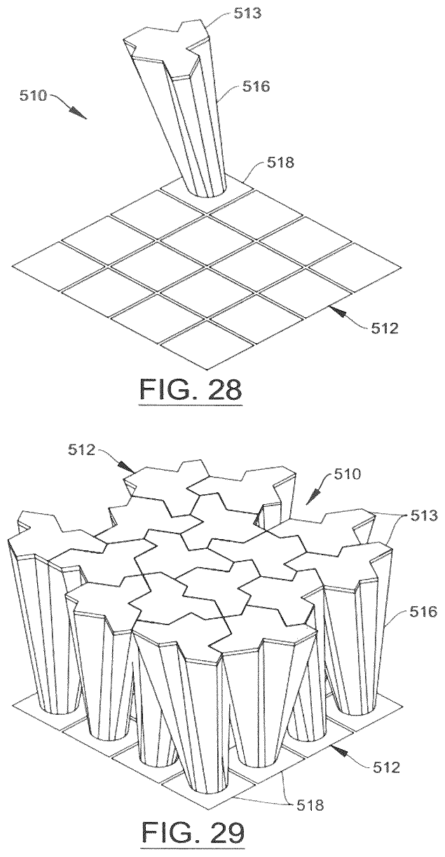

There are major advantages to building a bespoke sensor with an einstein sensor on the chip. But making such einstein sensors on a chip is not the only possible approach. As illustrated diagrammatically in FIG. 28, one could also assemble an einstein sensor device 510 with a conventional square-tile sensor array 512 and place an einstein micro-lens array 514 on top. Such an einstein micro-lens array 514 can be made as a molded optic comprising an array of individual micro-lenses 513, since the micro-lenses 513 do not need to be very high quality. The only function of the micro-lens array is to take the light that passes through from the top and redirect it in light beams 516 to the focus regions of the individual square sensors 518 of the sensor array 512, which needs only to lie somewhere within the center of the corresponding square-sensor 518, as shown in FIG. 28 and FIG. 29.

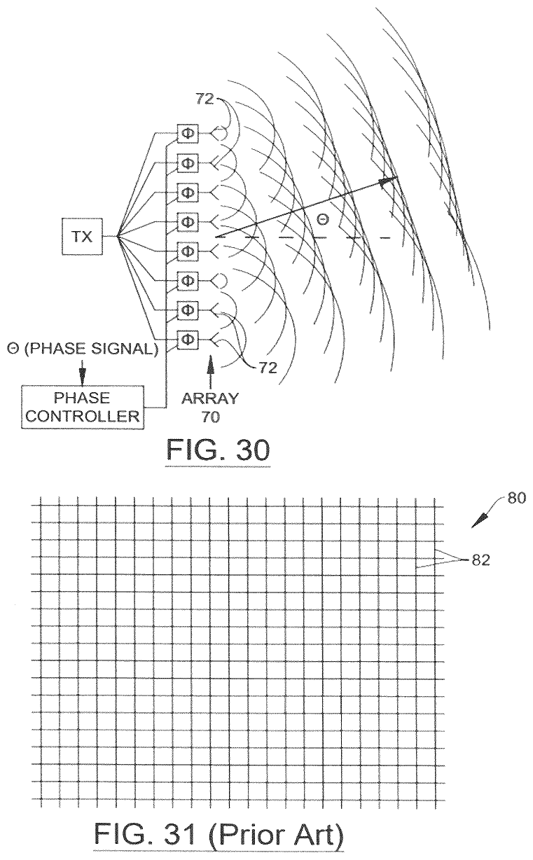

As mentioned above, another application area for and einstein element array, and especially a curve-sided einstein electrically addressable antenna transmitter or receiver array is as a phased-array antenna (PAA) system in both the RF and sonar regimes. These arrays comprise a group of individual antennas, arranged in different patterns for different uses, and apply either a phase shift or a time delay to transmit or receive radio transmissions at different angles Θ relative to the face of the array. FIG. 30 shows a typical transmitter arrangement where a signal (TX) is used to modulate array 70 elements 72, while a phase controller delays the signal differently for different array elements 72, causing the combined signal to adopt an angle, Θ, on exit. The array 70, shown in only one dimension in FIG. 30, is actually a 2-dimensional array, and each transmitter element 72 of the array 70 can be a curve-sided einstein electrically addressable transmitter element 72, as explained above, so that the array 70 is aperiodic. The same principle, used in reverse, i.e., with curve-sided einstein electrically addressable receiver elements in a receiver array, allows the antenna to select and receive a signal from any selected direction while suppressing off-angle activity.

As in the optical sensor and modulator applications, in some applications a PAA is adversely affected by the spacing of its transmitter or receiver elements. Since the signal can be transmitted or received from many angles, a periodic arrangement of the antenna array elements always has uneven performance, since it will have directions that are better or worse due to its geometry. sidelobe suppression has been attempted by separating the elements by one wavelength or more, but this has unwanted side effects. If a whole PAA is used as a single element, aimed at a single target, the best arrangement of its elements would be radial. But if, as is often the case, more flexibility is needed to simultaneously aim different arbitrary regions of the array at different targets, the best that can be done with current conventional technology is a rectangular array 80 with rectangular transmitter or receiver elements 82 as illustrated diagrammatically in FIG. 35. But that arrangement with square transmitter or receiver elements 82 has uniformity issues, since the square elements 82 in diagonal directions have less on-axis resolution than the on-axis elements 82 in the orthogonal directions. If the rectangular array 80 is replaced with curve-sided einstein transmitter or receiver elements of the same number of elements, all directions have an equal isotropic resolution, which will result in the minimization of sidelobes and stronger directionality.

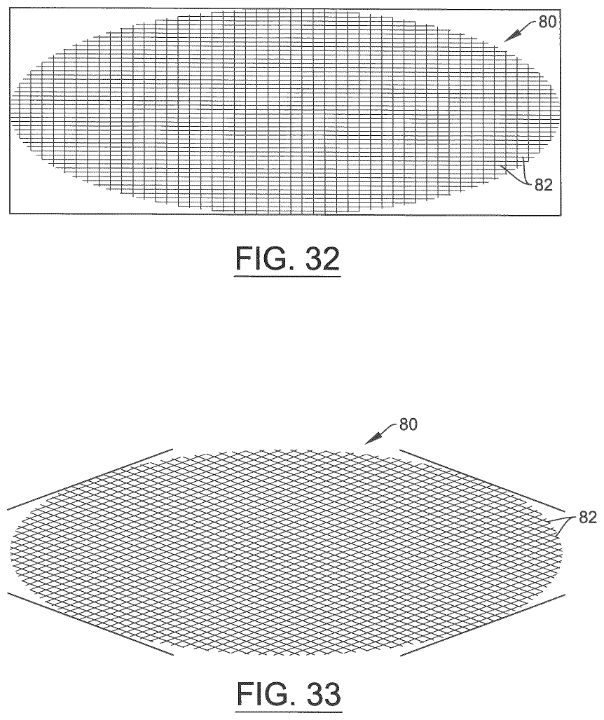

Let's look at the current possible array architectures prior to this invention and see why they cannot have truly uniform isotropic performance. Essentially the signals are mixed with the diffraction pattern of the antenna, resulting in sidelobes. As we saw in FIG. 20, this is a major source of noise and inefficiency and is manifested in antennas as sidelobes. The most common generic PAA uses square elements, as illustrated diagrammatically in FIG. 31. Used to direct or select a beam at an angle, the elements 82 do not have an isotropic arrangement. This does not mean that the antenna cannot work at any angle, but it does mean that the signal will not be as uniform as it would be for a true isotropic array. FIG. 32 and FIG. 33 show the same antenna array 80 with its square transmitter or receiver elements 82, but viewed obliquely at 0° and 45°, respectively. The density and shape of the elements 82 is visibly different and will always deliver the same type of directional nonuniformity. Even some aperiodic arrays, using Penrose tiles have strong dissimilar structure along their rows and columns, besides variations in the tile area, since they are not monotiles, which limits their isotropicity and practicality. Another possible approach is to simply scatter array elements in an aperiodic pattern. Although that approach effectively eliminates repetitive patterns, it loses efficiency, because it necessarily has “dead space” between elements.

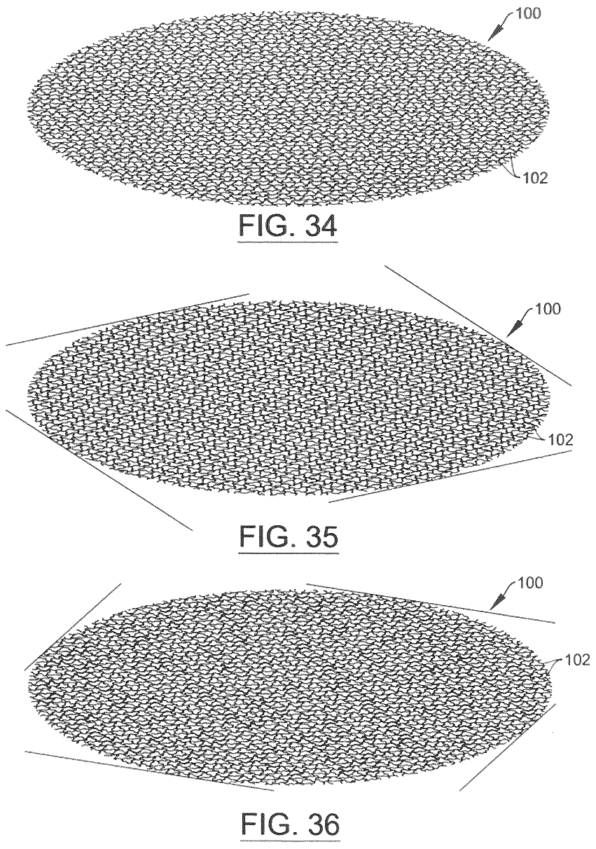

On the other hand, an array 100 of curve-sided einstein transmitter or receiver elements 102, as illustrated in FIGS. 34, 35, 36 has the advantage of regular tiling giving 100% area coverage without directional nonuniformity and offers true omnidirectional (isotropic) performance. The math necessary to properly delay the transmitter or receiver elements 102 is more complex, but it is typically derived once and reused as needed. Regardless of orientation, the array 100 looks substantially the same at 0°, 45°, and 135°, as illustrated diagrammatically in FIGS. 34, 35, and 36 respectively and will support a uniform isotropic directionality. There are no “cold” or “hot” directions, and there are no dead spaces.

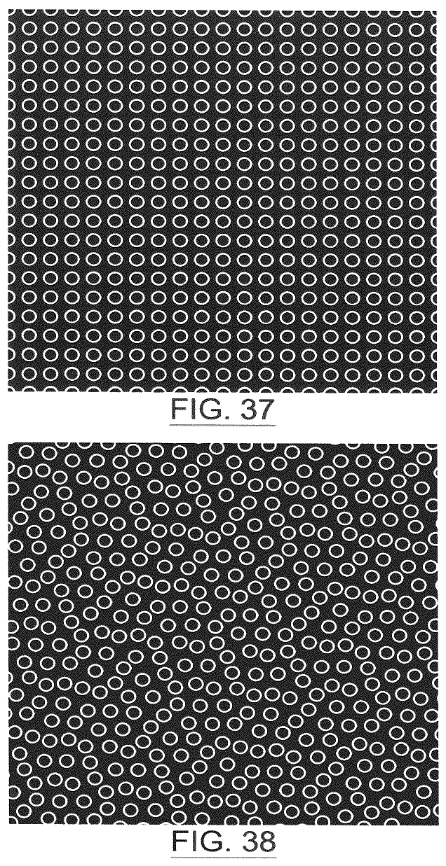

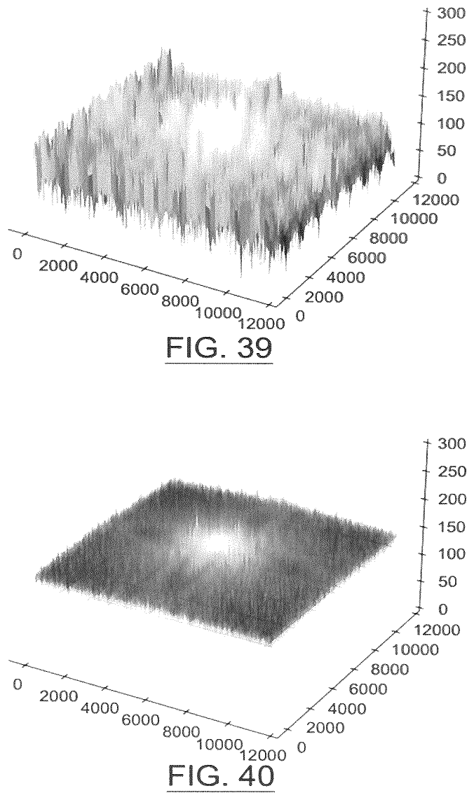

Some phased array antennas might not benefit from the “edge details” of a curve-sided einstein electrically addressable antenna elements since they largely modulate or sense features that are larger than individual elements. But the placement of the antenna elements is enhanced by using the aperiodic location of the center-of-mass of the curve-sided einstein electrically addressable antenna elements. Consider a typical square row-and-column antenna with circular elements (FIG. 37) versus an antenna with the same number, size, and mean spacing of elements in an aperiodic fashion, mimicking the locations from an array of curve-sided einstein electrically addressable antenna elements, as illustrated in FIG. 38. Because typical antenna elements have a regular periodic arrangement, they will generate a strong Fourier pattern which will be superimposed on their signal as seen in FIG. 39. The same antenna elements at the same density in an aperiodic arrangement are much quieter as shown by the Fourier transform in FIG. 40, which translates to fewer sidelobes, and higher signal strength.

The foregoing description is considered as illustrative of the principles of the invention. Furthermore, since numerous modifications and changes will readily occur to those skilled in art, it is not desired to limit the invention to the exact construction and process shown and described above. Accordingly, resort can be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

1. An aperiodic array, comprising:
a plurality of einstein electrically addressable elements tessellated together in an array of multiple rows and multiple columns;
a plurality of electric row buses, one of the row buses for each of the rows, wherein the respective row buses are connected electrically to each of the einstein electrically addressable elements in that row; and
a plurality of electric column buses, one of the column buses for each of the columns, wherein the respective column buses are connected electrically to each of the einstein electrically addressable elements in that row.

2. The aperiodic array of claim 1, wherein each of the einstein electrically addressable elements has a 13-sided polygon shape.

3. The aperiodic array of claim 1 wherein each of the einstein electrically addressable elements has a perimeter edge comprising fourteen side segments, wherein each of the side segments extends between two end points that are spaced a distance apart from each other, and wherein the distance that the two end points are spaced apart from each other is the same for all of the fourteen side segments.

4. The aperiodic array of claim 3, wherein each of the fourteen side segments is straight, whereby the einstein electrically addressable element has a polygon shape.

5. The aperiodic array of claim 4, wherein each of the fourteen side segments has an orientation and another one of the side segments has a matching orientation.

6. The aperiodic array of claim 3, wherein each of the fourteen side segments is curved.

7. The aperiodic array of claim 6, wherein seven of the fourteen side segments have concave curvatures and seven of the fourteen side segments have convex curvatures, wherein the side segments that have concave curvatures alternate with the side segments that have concvex curvatures.

8. The aperiodic array of claim 6, wherein the curvatures of the side segments are arcs of a circle.

9. The aperiodic array of claim 8, wherein each of the arcs has an angle, and wherein the angle of each of the arcs is the same.

10. The aperiodic array of claim 8, wherein each of the arcs has a radius, and wherein each of the radii of all of the arcs are the same.

11. The aperiodic array of claim 8, wherein each of the radii is within a range of 95% to 115% of the distance between the end points of the side segment.

12. The aperiodic array of claim 8, wherein each of the radii is equal to the distance between the end points of the side segment.

13. The aperiodic array of claim 6, wherein each of the side segments as a mirror partner with the same orientation.

14. The aperiodic array of claim 6, wherein each of the side segments comprises multiple alternating concave and convex curvatures.

15. The aperiodic array of claim 7, wherein the multiple alternating concave and convex curves are half-circles.

16. The aperiodic array of claim 15, wherein each of the half-circles has a radius, and the length of the radius is a range of 0.25×D to 0.275×D, wherein D is the distance that the two end points are spaced apart from each other.

17. The aperiodic array of claim 1, wherein the einstein electrically addressable elements include light sensors.

18. The aperiodic array of claim 1, wherein the einstein electrically addressable elements include light modulators.

19. The aperiodic array of claim 1, wherein the einstein electrically addressable elements include light emitters.

20. The aperiodic array of claim 1, wherein the einstein electrically addressable elements include antenna transmitters.

21. The aperiodic array of claim 1, wherein the einstein electrically addressable elements include antenna receivers.
